(19) United States
(12) Patent Application Publication
(10) Pub. No.: US 2013/0009907 A1
(43) Pub. Date: Jan. 10, 2013

(54) Magnetic Stylus

(76) Inventors: Ilya D. Rosenberg, Mountain View, CA (US); Bradley J. Bozarth, Sunnyvale, CA (US); Julien G. Beguin, San Francisco, CA (US); Tomer Moscovich, San Francisco, CA (US); Susan Jie Gao, Santa Clara, CA (US); Tiffany Yun, Fremont, CA (US)

(21) Appl. No.: 13/247,412

(22) Filed: Sep. 28, 2011

Related U.S. Application Data
(63) Continuation-in-part of application No. 12/846,539, filed on Jul. 29, 2010.
(60) Provisional application No. 61/230,592, filed on Jul. 31, 2009.
(60) Provisional application No. 61/263,015, filed on Nov. 20, 2009.

(51) Int. Cl. G06F 3/046; G06F 3/033

(52) U.S. Cl. 345/174; 345/179

(57) ABSTRACT

A stylus comprising a magnetic field source when combined with a touch sensor provides for several input modes for an electronic device. Magnetometers in the electronic device may detect the presence, location, orientation, and angle of the magnet and thus the stylus. Presence of the magnetic field in conjunction with touches on the force sensitive touch sensor provides additional comparisons to distinguish whether a touch is from a human hand, a particular portion of a stylus, or other object.

### PRIORITY

The present application is a continuation-in-part of pending U.S. application Ser. No. 12/846,539, filed on Jul. 29, 2010, entitled “Magnetic Touch Discrimination”, which claims priority to U.S. Provisional Application Ser. No. 61/230,592, filed on Jul. 31, 2009, entitled “Inventions Related to Touch Screen Technology” and U.S. Provisional Application Ser. No. 61,263,015, filed on Nov. 20, 2009, entitled “Device and Method for Distinguishing a Pen or Stylus Contact from the Contact of a Finger or other Object Using Magnetic Sensing.” These pending applications are herein incorporated by reference in their entirety, and the benefit of the filing date of this pending application is claimed to the fullest extent permitted.

### BACKGROUND

Electronic devices that accept input from users are ubiquitous, and include cellular phones, eBook readers, tablet computers, desktop computers, portable media devices, and so forth. Increasingly, users desire these devices to accept input without the use of traditional keyboards or mice.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts an electronic device configured to accept input from devices including a touch sensor and a magnetometer.

FIG. 2 is an illustrative schematic of the electronic device with an input module configured to use the touch sensor, the magnetometer, or both to accept user input.

FIG. 3 is an illustration of a human hand and defines some contact areas the hand encounters when in contact with a surface such as the touch sensor.

FIG. 4 illustrates contact areas of several objects that make contact with the touch sensor, including a stylus point, a stylus end, a finger, and a human palm.

FIG. 5 illustrates an example linear force distribution the objects of FIG. 4 when these objects contact the touch sensor.

FIG. 6 is an illustrative process of identifying a user based at least in part upon a touch profile.

FIGS. 7A and 7B are cross sections of illustrative styli comprising a primary alignment magnet.

FIG. 8 is a cross section of an illustrative stylus configured to allow displacement of the primary alignment magnet.

FIG. 9 is a cross section of the stylus of FIG. 8 after displacement of the primary alignment magnet.

FIG. 10 is a cross section of an illustrative stylus comprising a primary alignment magnet and an electromagnet.

FIG. 11 is a cross section of an illustrative stylus configured to accept a squeeze input.

FIG. 12 is a cross section of the stylus of FIG. 11 when squeezed.

FIG. 13 is a plan view of the electronic device and a magnetometer detecting a relative angular bearing and a relative magnetic field strength of the magnetic field from one or more magnets within the stylus.

FIG. 14 is a cross section of the electronic device of FIG. 13.

FIG. 15 is a plan view of the electronic device and plurality of magnetometers, each of the magnetometers detecting a relative angular bearing and a relative magnetic field strength of the magnet within the stylus.

FIG. 16 is a cross section of the electronic device of FIG. 15.

FIG. 17 is an illustrative process of determining a position of a magnetic field source based upon data from one or more magnetometers and modifying output at least partly in response.

FIG. 18 is an illustrative process of generating a position of the stylus based on a model of the magnetic field.

FIG. 19 is an illustrative process of further determining the position and orientation of a magnetic field source based upon angular bearing, magnetic field strength, or both, to one or more magnetometers.

FIG. 20 is an illustrative process of determining a tilt angle of the stylus and applying an offset error correction to the input.

FIG. 21 is an illustrative process of distinguishing between a non-stylus (e.g. a finger) touch and a stylus (e.g. non-finger) touch based upon the presence or absence of a magnetic field source at the location of a touch on a touch sensor.

FIG. 22 is an illustrative process of distinguishing between a non-stylus touch and a stylus touch, which end of a magnetic stylus is in contact with a touch sensor based at least in part upon the magnetic field orientation.

FIG. 23 is an illustrative process of designating a touch as a non-input touch.

FIG. 24 is an illustrative process of distinguishing between a non-stylus touch and a stylus touch based upon the presence or absence of a magnetic field source and determining which end of a magnetic stylus is in contact based at least in part upon the magnetic field orientation.

FIG. 25 illustrates a three-dimensional gesture input using a magnetic stylus.

FIG. 26 illustrates varying presentation of one or more portions of a user interface at least partly in response to a relative distance between the stylus and the touch sensor.

FIG. 27 is an illustrative process of modifying an input line width based at least partly in response to a tilt angle of the stylus relative to the touch sensor.

FIG. 28 is an illustrative process of modifying a user input based at least in part on a determined grip by the user of the stylus.

FIG. 29 is an illustrative process of applying a pre-determined visual affect to one or more points corresponding to non-stylus input.

FIG. 30 is an illustrative implementation of device with a receptacle configured to magnetically stow the stylus and configured to detect presence of the stylus in the receptacle.

FIG. 31 is an illustrative process of determining a change in ambient magnetic fields resulting from placement of the stylus and altering a power consumption mode in response.

### DETAILED DESCRIPTION

### Overview

Described herein are devices and techniques for accepting input in an electronic device. These devices include a stylus containing a magnet, magnetic field sensors, and one or more touch sensors. By generating information from the magnetic field sensors about the position or orientation of the stylus, the described devices and techniques enable rich input modes alone or in combination with one another.

Touch sensors are used in a variety of devices ranging from handheld e-book reader devices to graphics tablets on desktop computers. Users interact with the devices in a variety of ways and in many different physical environments and orientations. During stylus use, such as while writing or drawing on the touch sensor, part of the user's palm may rest on the touch sensor. By determining magnetically the position of the stylus, palmar touches or other unintentional touches may be designated as non-input touches and disregarded by a user interface.

The touch sensor may also be used in the identification of a user. For example a user may place their palm against the touch sensor to generate a touch profile. By comparing that touch profile with previously stored touch profiles, the user's identity may be determined.

The magnetic stylus is configured to generate one or more magnetic fields which may be detected by magnetic field sensors, such as magnetometers, in the device. A tactile element such as a spring or elastomeric material may be incorporated into the structure of the stylus to provide an improved tactile experience to users. For ease of description, the magnetic stylus is also referred to herein as simply a “stylus”. It is understood that the stylus incorporates at least one magnet, but need not be entirely magnetic.

The magnetic stylus may also vary a magnetic field signal by being configured to allow the user to physically displace one or more magnets within the stylus, such that the magnetic field moves relative to a body of the stylus.

Given the stylus being in contact with a touch sensor, the change is detectable as being due to displacement of the magnet and not movement of the stylus body. This detected change in the magnetic field may be used to indicate a user input, such as activating a menu of available options.

The magnetic stylus may be passive and unpowered, or may include an active component such as an electromagnet. Upon activation, the electromagnet generates a magnetic field signal which is detectable by the magnetometers. The detected signal may be accepted as a user input, such as a “click” action in selecting a particular function in a user interface.

The magnetic stylus may also vary touch input presented to the touch sensor. The stylus may be configured such that when squeezed, the magnitude of force applied via a tip is increased. This increase in magnitude of force on the tip may be accepted as user input, such as varying the thickness of a line or selecting a particular function in the user interface.

The magnetic field sensors, such as a magnetometer, allow for the detection and characterization of an impinging magnetic field. For example, a magnetometer may allow for determining a field strength, angular bearing, polarity of the magnetic field, and so forth. In some implementations, the magnetometer may comprise a Hall-effect device, vector magnetometer, coil magnetometer, fluxgate magnetometer, spin-exchange relaxation-free atomic magnetometers, anisotropic magnetoresistance (AMR), tunneling magnetic resistance (TMR), giant magnetoresistance (GMR), magnetic inductance, and so forth. Magnetometers which are not magnetized by strong magnetic fields may be preferred in some implementations. Magnetometers which may become magnetized may be accompanied by a degaussing mechanism. The magnetometers may comprise a plurality of sensing elements to provide a three-dimensional magnetic field vector. Magnetic fields, particularly in the environment within which electronic devices operate, are predictable and well understood. As a result, it becomes possible to use one or more magnetometers to determine presence and in some implementations the position, orientation, rotation, and so forth of the magnetic stylus.

Touches may be distinguished based on the presence or absence of the magnetic field. For example, when no magnetic field meeting pre-defined criteria is present, a touch may be determined to be a finger touch, in contrast to when the magnetic field having the pre-defined criteria is present which determines the touch to be the magnetic stylus. In another example, which end of a stylus is touching the touch sensor is distinguishable independent of the touch profile of the stylus based on the polarity of the magnetic field detected. The pre-defined criteria of the magnetic field may include field strength, direction, and so forth. These characteristics of the magnetic field allow for additional user input and modes. For example, the width of a line being drawn on a display may be varied depending upon the tilt of the magnetic stylus with respect to some point, line, or plane of reference. In another example, an offset correction resulting from the tilt may be applied.

Additionally, by using the position information of the magnetic stylus, non-contact or near-touch sensing is possible. For example, movement of the stylus proximate to the magnetometer but not in contact with the touch sensor may still provide input. Thus, three-dimensional input gestures involving the stylus may also be used as input.

Reducing power consumption in electronic devices offers several benefits such as extending battery life in portable devices, thermal management, and so forth. Sensors such as the touch sensors and magnetic field sensors described herein consume power while operational. Data obtained by the magnetometers as to the placement or position of the stylus may be used to change a power consumption mode of the device. For example, while the stylus is present in a receptacle on the device, the processor and other devices may be placed into a low power consumption mode which consumes less power than a normal power consumption mode. Likewise, removal of the stylus from the receptacle may be used as a trigger to resume the normal power consumption mode.

### Illustrative Device

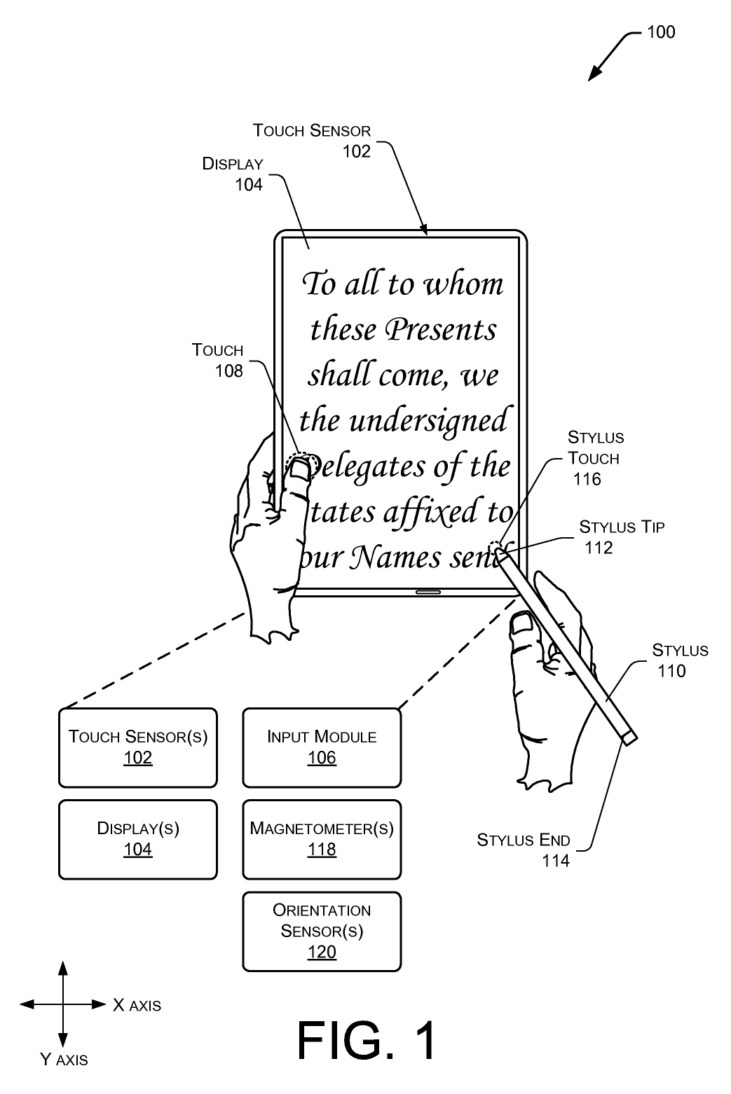

FIG. 1 depicts an electronic device 100 configured with a touch sensor, magnetometer, and other sensors. A touch sensor 102 accepts input resulting from contact and/or application of incident force, such as a user finger or stylus pressing upon the touch sensor. While the touch sensor 102 is depicted on the front of the device, it is understood that other touch sensors 102 may be disposed along the other sides of the device instead of, or in addition to, the touch sensor on the front. A display 104 is configured to present information to the user. In some implementations, the display 104 and the touch sensor 102 may be combined to provide a touch-sensitive display, or touchscreen display.

Within or coupled to the device, an input module 106 accepts input from the touch sensor 102 and other sensors. For example, as depicted here with a broken line is a user touch 108 on the touch sensor 102. Also depicted is a stylus 110 having two opposing terminal structures, a stylus tip 112 and a stylus end 114. The stylus tip 112 is shown in contact with the touch sensor 102 as indicated by the stylus touch 116. In some implementations, the stylus tip 112 may be configured to be non-marking such that it operates free without depositing a visible trace of material such as graphite, ink, or other material.

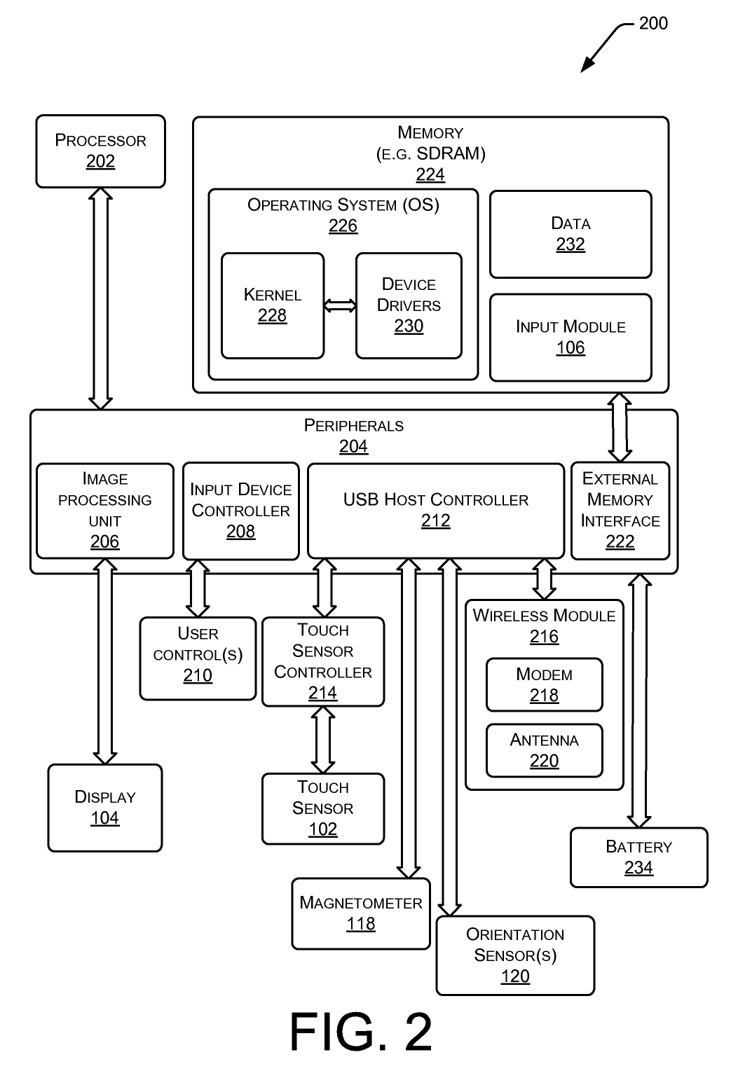

Returning to the sensors within the device 100, one or more magnetometers 118 are accessible to the input module 106. These magnetometers are configured to detect and in some implementations characterize impinging magnetic fields along one or more mutually orthogonal axes. This characterization may include a linear field strength and polarity along each of the axes. One or more orientation sensors 120 such as accelerometers, gravimeters, and so forth may also be present. These sensors are discussed in more detail next with regards to FIG. 2.

FIG. 2 is an illustrative schematic 200 of the electronic device 100 of FIG. 1. In a very basic configuration, the device 100 includes components such as a processor 202 and one or more peripherals 204 coupled to the processor 202. Each processor 202 may itself comprise one or more processors.

An image processing unit 206 is shown coupled to one or more display components 104 (or “displays”). In some implementations, multiple displays may be present and coupled to the image processing unit 206. These multiple displays may be located in the same or different enclosures or panels. Furthermore, one or more image processing units 206 may couple to the multiple displays.

The display 104 may present content in a human-readable format to a user. The display 104 may be reflective, emissive, or a combination of both. Reflective displays utilize incident light and include electrophoretic displays, interferometric modulator displays, cholesteric displays, and so forth. Emissive displays do not rely on incident light and, instead, emit light. Emissive displays include backlit liquid crystal displays, time multiplexed optical shutter displays, light emitting diode displays, and so forth. When multiple displays are present, these displays may be of the same or different types. For example, one display may be an electrophoretic display while another may be a liquid crystal display.

For convenience only, the display 104 is shown in FIG. 1 in a generally rectangular configuration. However, it is understood that the display 104 may be implemented in any shape, and may have any ratio of height to width. Also, for stylistic or design purposes, the display 104 may be curved or otherwise non-linearly shaped. Furthermore the display 104 may be flexible and configured to fold or roll.

The content presented on the display 104 may take the form of user input received when the user draws, writes, or otherwise manipulates controls such as with the stylus. The content may also include electronic books or “eBooks.” For example, the display 104 may depict the text of an eBooks and also any illustrations, tables, or graphic elements that might be contained in the eBooks. The terms “book” and/or “eBook”, as used herein, include electronic or digital representations of printed works, as well as digital content that may include text, multimedia, hypertext, and/or hypermedia. Examples of printed and/or digital works include, but are not limited to, books, magazines, newspapers, periodicals, journals, reference materials, telephone books, textbooks, anthologies, instruction manuals, proceedings of meetings, forms, directories, maps, web pages, and so forth. Accordingly, the terms “book” and/or “eBook” may include any readable or viewable content that is in electronic or digital form.

The device 100 may have an input device controller 208 configured to accept input from a keypad, keyboard, or other user actuable controls 210. These user actuable controls 210 may have dedicated or assignable operations. For instance, the actuable controls may include page turning buttons, a navigational keys, a power on/off button, selection keys, a joystick, a touchpad, and so on.

The device 100 may also include a USB host controller 212. The USB host controller 212 manages communications between devices attached to a universal serial bus (“USB”) and the processor 202 and other peripherals.

FIG. 2 further illustrates that the device 100 includes a touch sensor controller 214. The touch sensor controller 214 couples to the processor 202 via the USB host controller 212 (as shown). In other implementations, the touch sensor controller 214 may couple to the processor via the input device controller 208, inter-integrated circuit (“I²C”) bus, universal asynchronous receiver/transmitter (“UART”) interface, or serial peripheral interface bus (“SPI”), or other interfaces. The touch sensor controller 214 couples to the touch sensor 102. In some implementations multiple touch sensors 102 may be present.

The touch sensor 102 may comprise utilize various technologies including interpolating force-sensing resistance (IFSR) sensors, capacitive sensors, magnetic sensors, force sensitive resistors, acoustic sensors, optical sensors, and so forth. The touch sensor 102 may be configured such that user input through contact or gesturing relative to the device 100 may be received.

The touch sensor controller 214 is configured to determine characteristics of interaction with the touch sensor. These characteristics may include the location of the touch on the touch sensor, magnitude of the force, shape of the touch, and so forth. In some implementations, the touch sensor controller 214 may provide some or all of the functionality provided by the input module 106, described below.

The magnetometer 118 may couple to the USB host controller 212, or another interface. The magnetometer 118, allows for the detection and characterization of an impinging magnetic field. For example, the magnetometer 118 may be configured to determine a field strength, angular bearing, polarity of the magnetic field, and so forth. In some implementations, the magnetometer may comprise a Hall-effect device. Magnetic fields, particularly in the environment within which electronic devices operate, are generally predictable and well understood. As a result, it becomes possible to use one or more magnetometers to determine the presence and in some implementations the position, orientation, rotation, and so forth of the magnetic stylus. A plurality of magnetometers 118 may be used in some implementations.

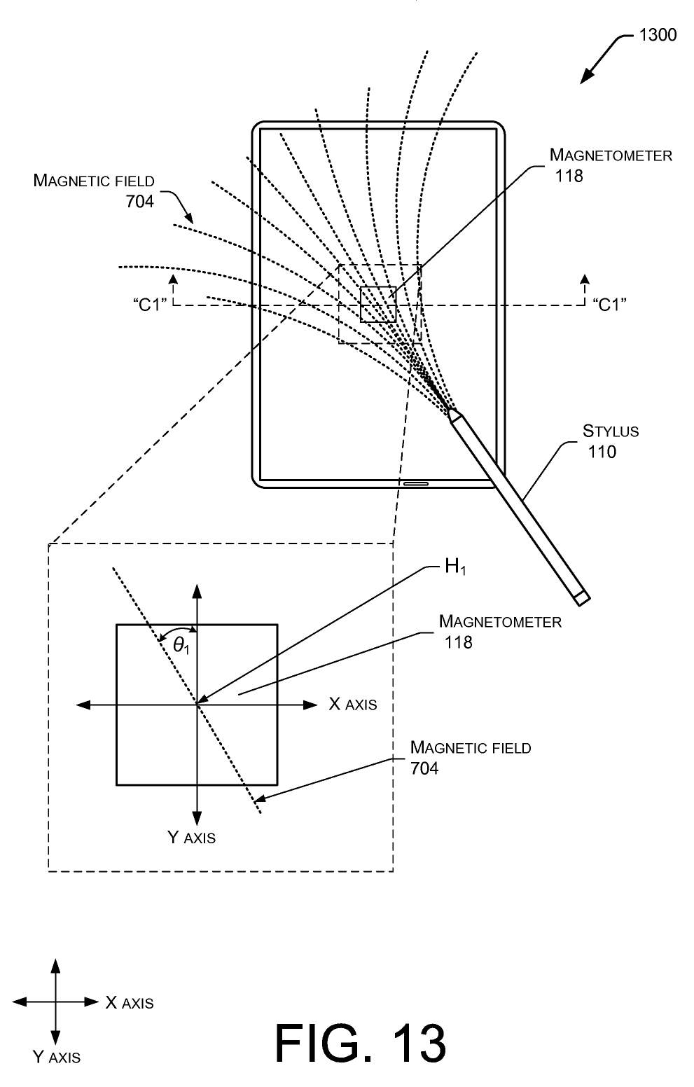

One or more orientation sensors 120 may also be coupled to the USB host controller 212, or another interface. The orientation sensors 120 may include accelerometers, gravimeters, gyroscopes, proximity sensors, and so forth. Data from the orientation sensors 120 may be used at least in part to determine the orientation of the user relative to the device 100. Once an orientation is determined, input received by the device may be adjusted to account for the user's position. For example, as discussed below with regards to FIG. 13, when the user is holding the device in a portrait orientation, the input module 106 may designate the left and right edges of the touch sensor the input module 106 designates these areas as likely holding touch areas. Thus, touches within those areas are biased in favor of being categorized as holding touches, rather than input touches.

The USB host controller 212 may also couple to a wireless module 216 via the universal serial bus. The wireless module 216 may allow for connection to wireless local or wireless wide area networks (“WWAN”). Wireless module 216 may include a modem 218 configured to send and receive data wirelessly and one or more antennas 220 suitable for propagating a wireless signal. In other implementations, the device 100 may include a wired network interface.

The device 100 may also include an external memory interface (“EMI”) 222 coupled to external memory 224. The EMI 222 manages access to data stored in external memory 224. The external memory 224 may comprise Static Random Access Memory (“SRAM”), Pseudostatic Random Access Memory (“PSRAM”), Synchronous Dynamic Random Access Memory (“SDRAM”), Double Data Rate SDRAM (“DDR”), Phase-Change RAM (“PCRAM”), or other computer-readable storage media.

The external memory 224 may store an operating system 226 comprising a kernel 228 operatively coupled to one or more device drivers 230. The device drivers 230 are also operatively coupled to peripherals 204, such as the touch sensor controller 214. The external memory 224 may also store data 232, which may comprise content objects for consumption on eBook reader device 100, executable programs, databases, user settings, configuration files, device status, and so forth. Executable instructions comprising an input module 106 may also be stored in the memory 224. The input module 106 is configured to receive data from the touch sensor controller 214 and generate input strings or commands. In some implementations, the touch sensor controller 214, the operating system 226, the kernel 228, one or more of the device drivers 230, and so forth, may perform some or all of the functions of the input module 106.

One or more batteries 234 provide operational electrical power to components of the device 100 for operation when the device is disconnected from an external power supply. The device 100 may also include one or more other, non-illustrated peripherals, such as a hard drive using magnetic, optical, or solid state storage to store information, a firewire bus, a Bluetooth™ wireless network interface, camera, global positioning system, PC Card component, and so forth.

Couplings, such as that between the touch sensor controller 214 and the USB host controller 212, are shown for emphasis. There are couplings between many of the components illustrated in FIG. 2, but graphical arrows are omitted for clarity of illustration.

### Illustrative Touch Profiles

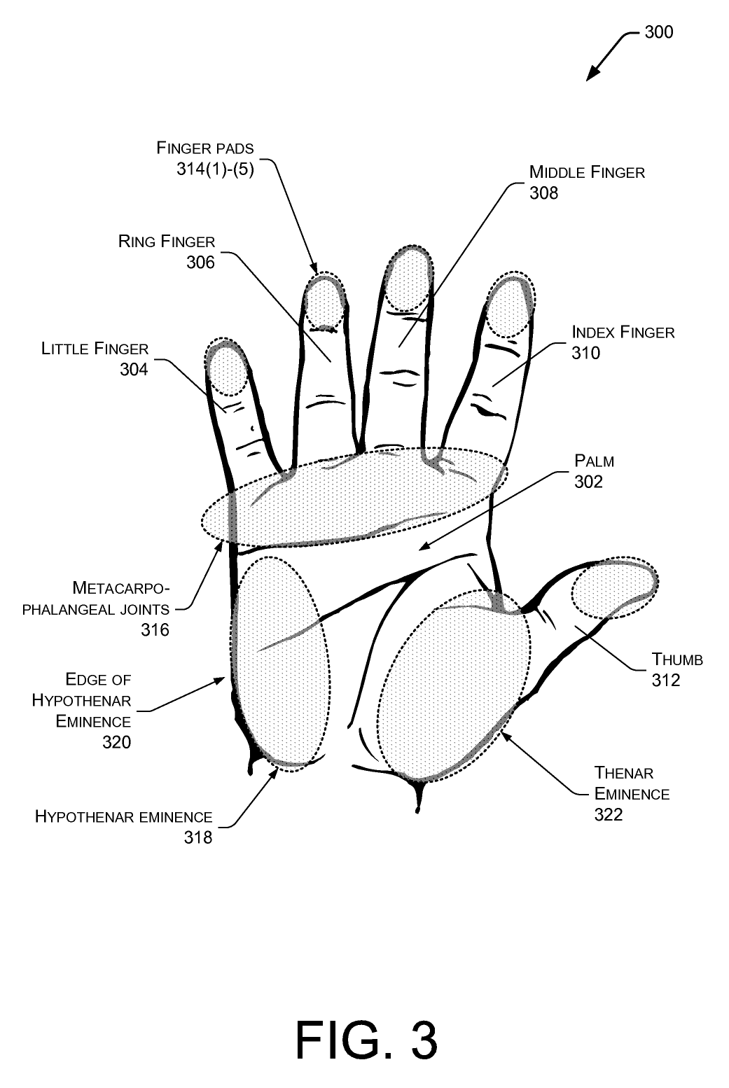

FIG. 3 is an illustration of a human hand 300. Touches may be imparted on the touch sensor 102 by implements such as styli or directly by the user, such as via all or a portion of the user's hand or hands. Centrally disposed is the palm 302, around which the fingers of the hand, including a little finger 304, ring finger 306, middle finger 308, index finger 310, and thumb 312 are disposed. The user may place finger pads 314 in contact with the touch sensor 102 to generate an input. In some implementations, the user may use other portions of the hand such as knuckles instead of, or in addition to, finger pads 314. The little finger 304, ring finger 306, middle finger 308, and index finger 310 join the palm in a series of metacarpophalangeal joints 316, and form a slight elevation relative to a center of the palm 302. On a side of the palm 302 opposite the thumb 312, a ridge known as the hypothenar eminence 318 is shown. The outer edge of the hand, colloquially known as the “knife edge” of the hand is designated an edge of the hypothenar eminence 320. Adjacent to where the thumb 312 attaches to the palm 302, a prominent feature is a thenar eminence 322.

The touch sensor 102 generates output corresponding to one or more touches at points on the touch sensor 102. The output from the touch sensors may be used to generate a touch profile which describes the touch. Touch profiles may comprise several characteristics such as shape of touch, linear force distribution, temporal force distribution, area of the touch, magnitude of applied force, location or distribution of the force, variation over time, duration, and so forth. The characteristics present within touch profiles may vary depending upon the output available from the touch sensor 102. For example, a touch profile generated by a projected capacitance touch sensor may have shape of touch and duration information, while a touch profile generated by an IFSR sensor may additionally supply force distribution information.

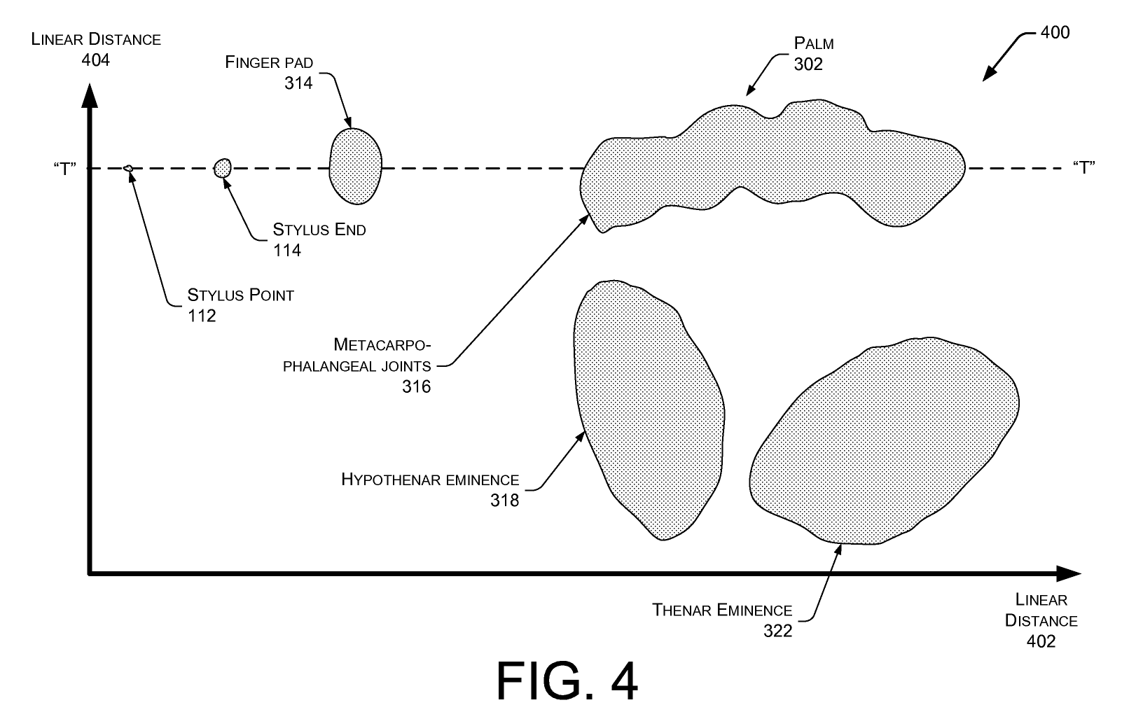

FIG. 4 illustrates contact areas 400 resulting from of the contact of several objects with the touch sensor 102. In this illustration, linear distance along an X-axis 402 is shown as well as linear distance along a Y Y-axis 404.

The touch profiles may comprise the contact areas 400. As shown here, the stylus point 112, when in contact with the touch sensor 102, generates a very small contact area which is roughly circular, while the stylus end 114 generates a larger, roughly circular, area. A contact area associated with one of the finger pads 314 is shown which is larger, still, and generally oblong.

Should the user's palm 302 come in contact with the touch sensor 102, the contact areas of the metacarpophalangeal joints 316, the hypothenar eminence 318, and the thenar eminence 322 may produce contact areas as shown. Other portions of the hand (omitted for clarity, and not by way of limitation) may come in contact with the touch sensor 102 during normal use. For example, when the user manipulates the stylus 110 to write on the touch sensor 102, the user may rest the hand which holds the stylus 110 on the touch sensor, resulting in sensing of the edge of the hypothenar eminence 320.

By monitoring the touches to the touch sensor 102 and building touch profiles, it becomes possible to dynamically adjust a user interface. For example, when the touch profile indicates small fingers such as found in a child, the user interface may automatically adjust to provide a simpler set of commands, reduce force thresholds to activate commands, and so forth.

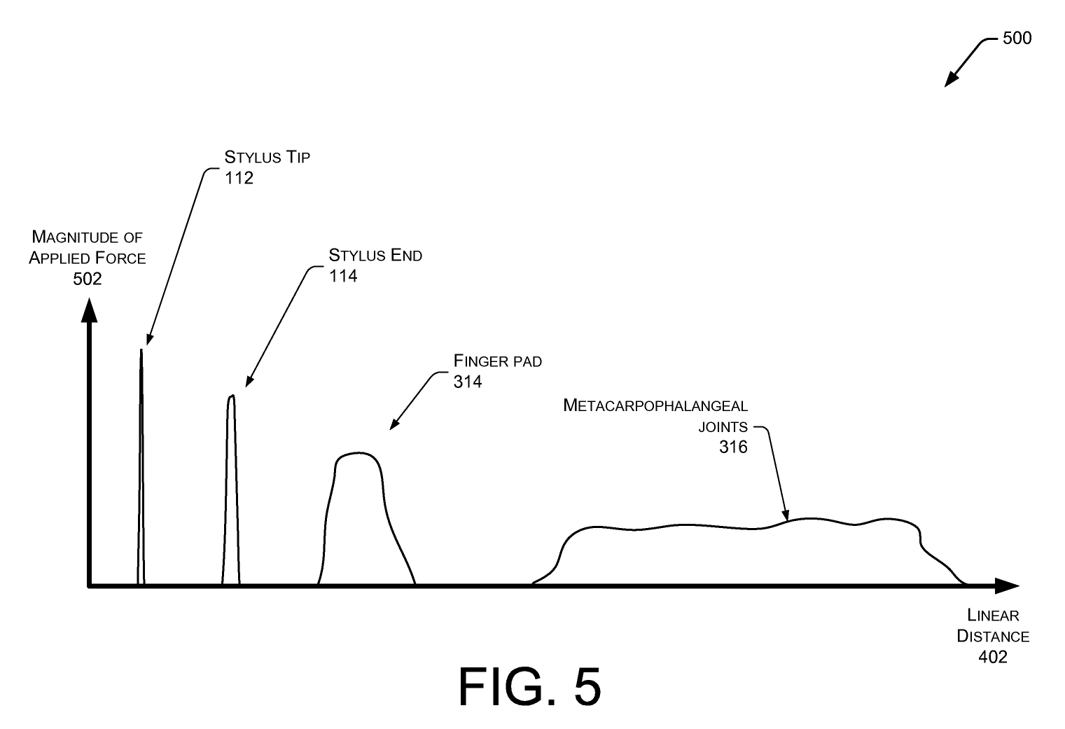

FIG. 5 illustrates a linear force distribution 500 of the touch profiles for the objects of FIG. 4. In this illustration, along the “Y” axis a magnitude of force 502 is shown for each of the objects shown in FIG. 4 along broken line “T” of FIG. 4. As shown, the stylus tip 112 produces a very sharp linear force distribution with steep sides due to its relatively sharp tip. The stylus end 114 is broader and covers a larger area than the stylus tip 112, but also has steep sides. In contrast, the finger pad 314 shows more gradual sides and a larger and more rounded distribution due to size and variable compressibility of the human finger. The metacarpophalangeal joints 316 are shown and cover a relatively large linear distance with relatively gradual sides and a much lower magnitude of applied force than that of the stylus tip 112, stylus end 114, and the finger pad 314. Also visible are pressure bumps resulting from the pressure of each of the four metacarpophalangeal joints 316. Thus, as illustrated here, the linear force distributions generated by different objects may be used to distinguish the objects.

Even when objects are distinguished, the objects themselves may produce intentional or unintentional touches. For example, the user may rest a thumb 312 or stylus on the touch sensor 102 without intending to initiate a command or enter data. It is thus worthwhile to distinguish intentional and unintentional touches to prevent erroneous input.

The processes in this disclosure may be implemented by the architectures described in this disclosure, or by other architectures. These processes described in this disclosure are illustrated as a collection of blocks in a logical flow graph, which represent a sequence of operations that can be implemented in hardware, software, or a combination thereof. In the context of software, the blocks represent computer-executable instructions that may be stored on one or more computer-readable storage media and that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes.

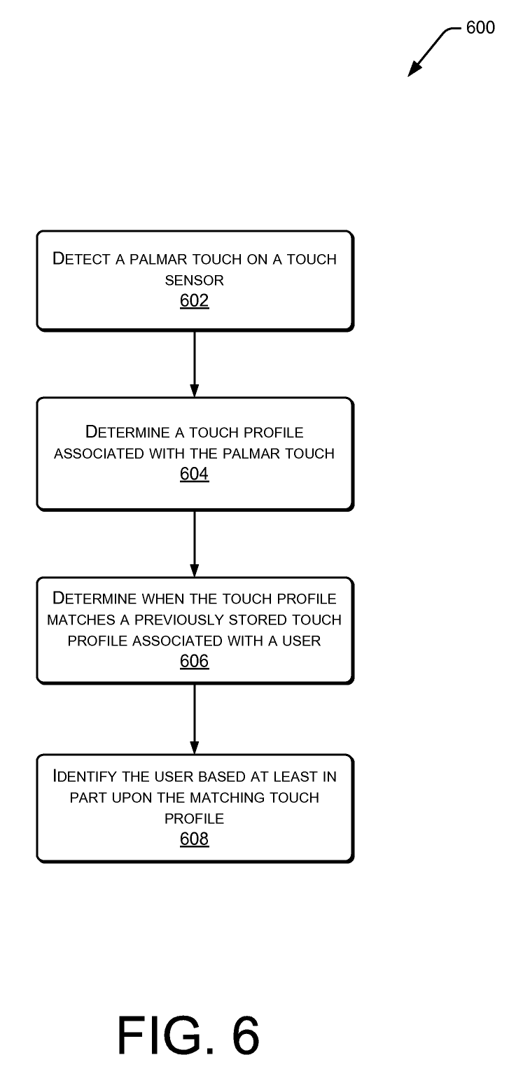

FIG. 6 is an illustrative process 600 of identifying a user based at least in part upon a touch profile. At 602, a touch of a palm 302 or palmar touch is detected on the touch sensor 102. For example, as described above the general shape of the touch may indicate that the touch is a palm.

At 604, a touch profile associated with the palmar touch is determined. For example, a user may place a palm flat against the touch sensor.

At 606, a match between the touch profile and a previously stored touch profile associated with a user is determined. The touch profiles may be stored in a datastore.

At 608, the user is identified based at least in part upon the matching touch profile. A touch profile may be determined to be matching when the previously stored touch profile and the current palmar touch have a correspondence above a pre-determined threshold. This identification may be used to provide access to content or functions, alter the user interface presented, and so forth. The user may also be identified by unique gestures, signature, writing style, stylus grip, and so forth.

### Illustrative Magnetic Stylus and Operation

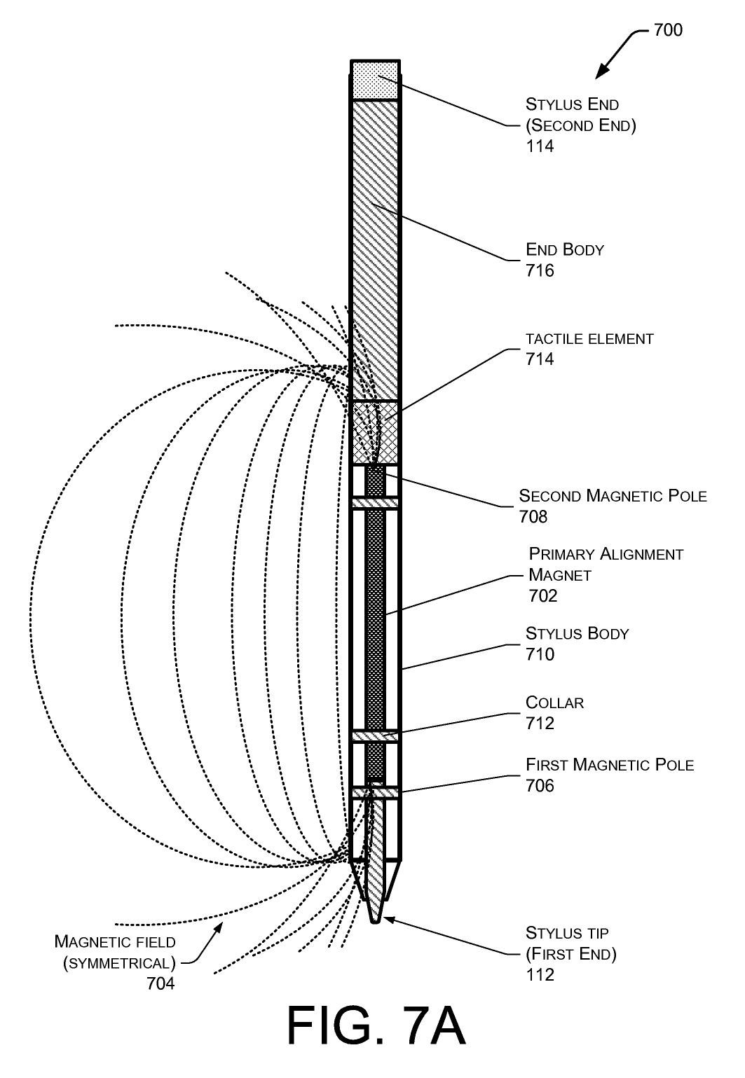

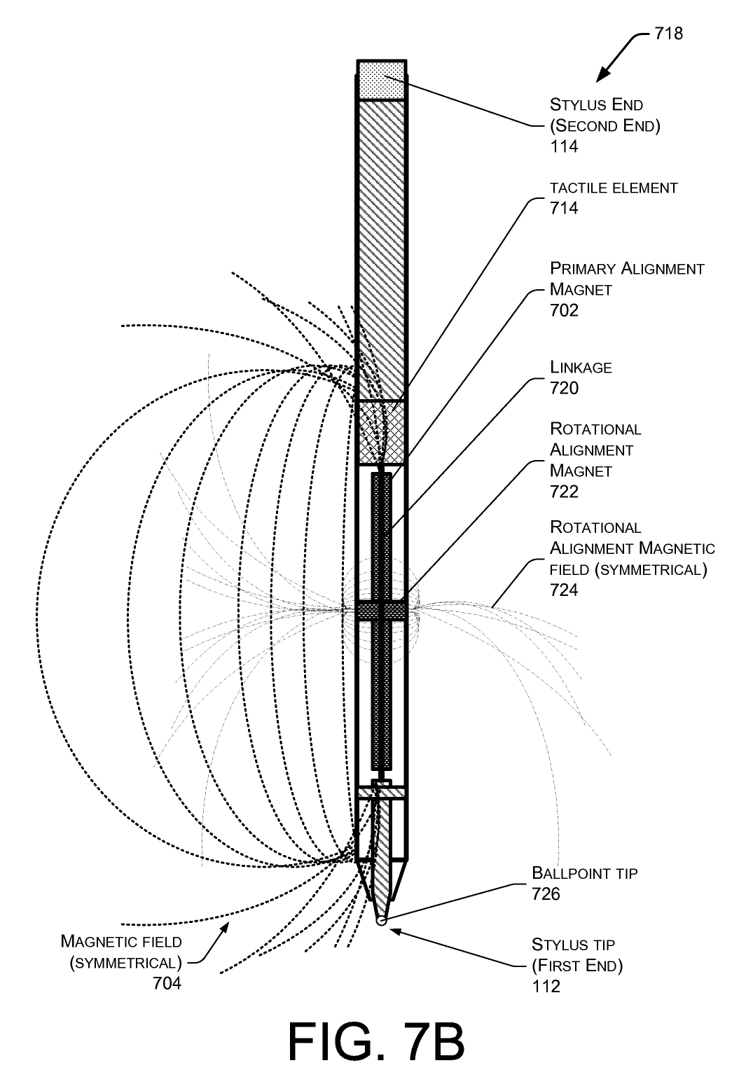

FIGS. 7A and 7B depict cross sections of illustrative magnetic styli. In these examples, the styli do not contains active components with electronic circuitry and internal power supplies and, therefore, reliability of the stylus is significantly improved and production cost is relatively low.

As illustrated in FIG. 7A, the stylus depicted 700 comprises a primary alignment magnet 702 is shown in a solid cylindrical form factor, with illustrated magnetic field lines 704 radiating generally symmetrically therefrom and extending from a first magnetic pole 706 to a second magnetic pole 708. The primary alignment magnet 702 is depicted encapsulated within a stylus body 710. In other implementations, the primary alignment magnet 702 may be disposed within a groove, affixed to the side of the stylus body 710, or otherwise coupled to the stylus body 710. In general, primary alignment magnet 702 can take on various sizes, shapes and geometries, and be located in various positions within the stylus. For example, the primary alignment magnet 702 may have an overall length of between about 10 and 200 millimeters and be configured in shapes including a solid rod, bar, hollow rod, torus, disk, and so forth. The primary alignment magnet 702 may be placed proximate to the stylus tip 112, stylus end 114, or at a position between these endpoints.

In one implementation the primary alignment magnet 702 may comprise two or more magnets coupled to a member capable of conveying magnetic flux, such as a ferrous metal. For example, a pair of small magnets may be coupled to opposite ends of an iron core to form the primary alignment magnet 702. Such an implementation may provide benefits such as reduced weight, reduced cost, altered balance of the stylus for improved ergonomics, and so forth.

The stylus body 710 may comprise a non-ferrous material, for example plastic or non-ferrous materials which provides no or minimal interference to the magnetic field. In other implementations, the stylus body 710 may comprise other materials which provide known interactions with the magnetic field such as ferrous materials.

One or more collars 712 are configured to maintain the position of the primary alignment magnet 702 and other structures within the stylus 110. These collars may be rigidly affixed to the stylus body 710, or configured to allow motion along a long axis of the stylus 110. The long axis of the stylus 110 extends from the tip 112 to the end 114.

A tactile element 714 may be placed within the stylus 110. The tactile element may comprise a spring, elastomeric material, or other structure configured to accept compression and return to substantially the same configuration in the absence of an applied force. The tactile element 714 is placed within the stylus 110 such that it provides some degree of motion along the long axis of the stylus 110 to the stylus tip 112, the stylus end 114, or both. In some implementations the stylus tip 112 may be coupled to a first tactile element 714 and the stylus end 114 may be coupled to a second tactile element 714. These tactile elements may be configured with different properties. For example the first tactile element may be more compressible than the second tactile element for the same amount of applied force.

In some implementations the stylus end 114 may couple to the tactile element 714 or another portion of the stylus via an end body 716. Such motion as afforded by the tactile element 714 provides for enhanced tactile feedback, and may also provide some degree of protection for the touch sensor 102, the display 104, or other surfaces with which the stylus tip 112 or end 114 comes into contact with. In some implementations the stylus tip 112, the stylus end 114, or other structures within the stylus may be configured to incorporate the tactile element 714. For example, in some implementations the stylus tip 112 may comprise an elastomeric material configured to allow the motion along the long axis of the stylus 110.

The input module 106 may be configured to recognize which end of the stylus is in use, and modify input accordingly. For example, input determined to be from the stylus tip 112 may be configured to initiate a handwriting function on the device 100, while input determined to be from the stylus end 114 may be configured to highlight text. In other implementations, orientation of the stylus 110 as flat relative to the touch sensor 102 and moved across the touch sensor 102 may be used a user input. In this orientation, the input module 106 may be configured to wipe or erase contents on the display 104 under the length of the stylus 110.

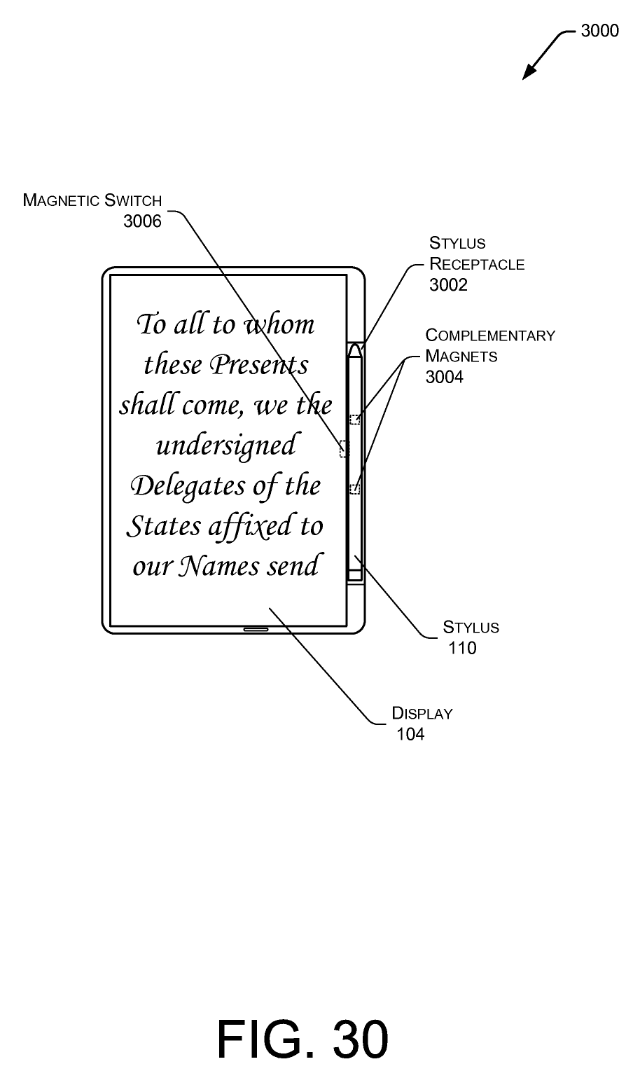

In some implementations, the primary alignment magnet 702 may also be configured to hold the stylus 110 to the electronic device 100 or an accessory such as a cover. This is discussed in more depth below with regards to FIG. 30.

FIG. 7B depicts another configuration 718 of magnetic stylus. The stylus tip 112 may be mechanically coupled to the tactile element 714 by a linkage 720. The linkage 720 may comprise a rod, bar, cylinder, or other structure configured to transmit mechanical pressure. For example, as shown here the linkage 720 transfers mechanical force between the stylus tip 112 and the tactile element 714, reducing or preventing mechanical stress on the primary alignment magnet 702 due to pressure on the stylus tip 112. Another linkage may also be used to couple the stylus end 114 to the tactile element 714.

In the implementation shown here, the stylus 110 may incorporate one or more magnets of the same or differing geometries and configured to generate a magnetic field of desired, strength, size and shape. For example, as shown here a rotational alignment magnet 722 may provide a magnetic field having an orientation different from that of the primary alignment magnet 702. This rotational alignment magnetic field 724 is illustrated here as being disposed generally at right angles to the magnetic field 704 provided by the primary alignment magnet 702. For clarity of illustration and not by way of limitation, a portion of the rotational alignment magnetic field 724 has been omitted. The input module 106 may be configured to recognize the magnetic field formed at least in part by the rotational alignment magnet 722 and determine a rotational orientation of the stylus 110 along the long axis of the stylus 110.

In some implementations the stylus 110 may be configured with a ballpoint tip 726 as also shown here. The ballpoint may be configured to provide a pre-determined level of rolling resistance. This pre-determined level of rolling resistance may be selected to provide a tactile response similar to that of a pen on paper, for example. The ballpoint tip 726 may be configured to dispense a fluid, which may act as a lubricant for a ball bearing within the ballpoint tip 726. This fluid may comprise a non-toxic material such as a silicone, hand lotion, and so forth. Where the stylus 110 is used in conjunction with a display 104, the fluid may be configured to provide reduced visual distortion to the displayed image. For example, the fluid may be optically clear.

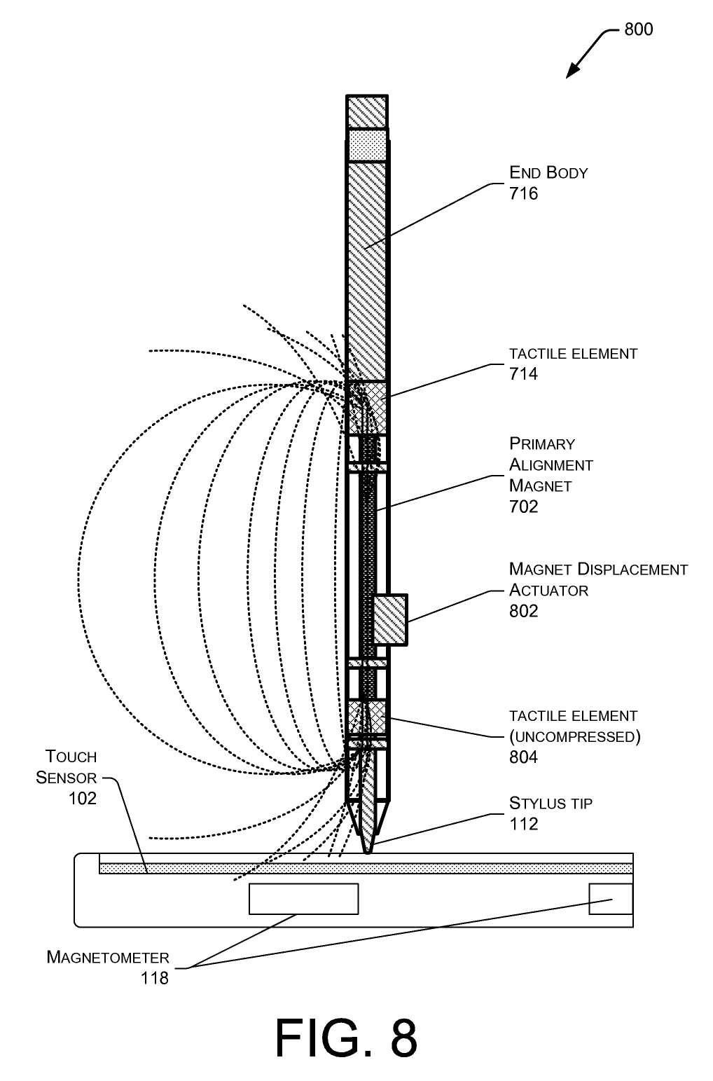

FIG. 8 is a cross section 800 of an illustrative stylus configured to allow the primary alignment magnet to be displaced. The magnetometers 118 within the device 100 are configured to detect magnetic fields, while the touch sensor 102 is configured to detect physical touches. When a portion of the stylus 110 is in contact with the touch sensor 102, a displacement of the magnetic field 704 along the long axis of the stylus 110 may be determined and distinguished from other motions of the stylus 110. This displacement of the field may thus be used as an input signal.

In this illustration, the stylus 110 is configured to allow the primary alignment magnet 702 to be displaced along the long axis via a magnetic displacement actuator 802. The actuator 802 may comprise a mechanical linkage, tab, or other feature configured to accept a force applied by the user and transfer that force into movement of the magnet. In this illustration, no force is applied to the magnet displacement actuator 802. As a result, a tactile element 804 is shown in a substantially uncompressed state. As described above, the tactile element 804 may be configured to mechanically couple to the stylus tip 112.

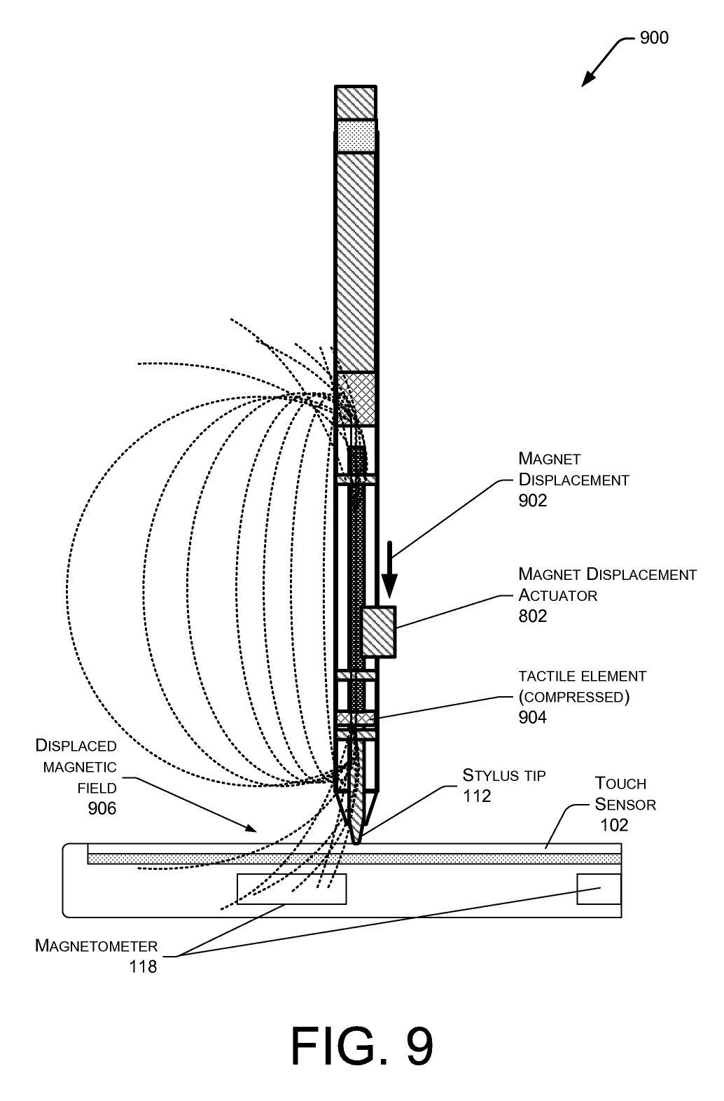

FIG. 9 is a cross section 900 of the stylus of FIG. 8 after displacement of the primary alignment magnet. As shown here, the magnet displacement actuator 802 has been displaced, such as by the user moving a finger. As a result, magnet displacement 902 occurs, resulting in at least a partial compression of a tactile element 904. The displacement of the magnet in turn results in a displaced magnetic field 906 which results in a changed signal to one or more of the magnetometers 118. Note that the overall position of the stylus 110 has remained the same relative to the device 100.

As described above, the changed signal resulting from the displaced magnetic field may be used as a user input. For example, the change in the magnetic field may be interpreted as a user input to select a command button in a user interface, activate a function, and so forth.

In other implementations another magnet of the stylus 110 may be displaced. For example, the rotational alignment magnet 722 may be configured to be displaced. Or an additional magnet may be present in the stylus 110 and displaced. Also, the displacement may occur in a direction other than along the long axis of the stylus 110. For example, the rotational alignment magnet 722 may be displaced by rotation about the long axis of the stylus 110.

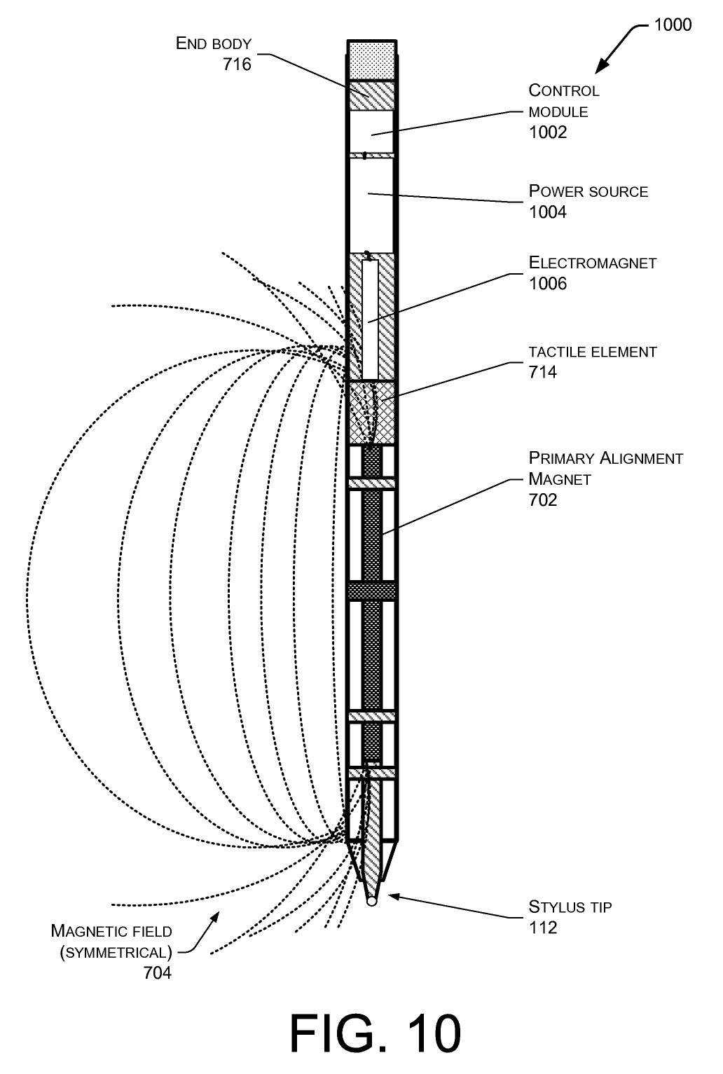

FIG. 10 is a cross section 1000 of another illustrative stylus, with this stylus including a primary alignment magnet and an electromagnet. In conjunction with the primary alignment magnet 702, a control module 1002, power source 1004, and electromagnet 1006 may be configured to generate a supplemental magnetic field when active. This magnetic field may be steady, transient, alternating, and so forth. When active, this supplemental magnetic field is configured to be detectable by the one or more magnetometers 118. By activating the electromagnet 1006, such as via a switch, the user may trigger the supplemental magnetic field which may be used to transfer data to the device 110. This data may be accepted by the input module 106 as user input.

For example, the stylus 110 may be configured with a plurality of user actuable switches. When activating a first switch, the electromagnet 1006 may be activated with a first magnetic field of a first polarity. This first magnetic field is detected by the one or more magnetometers 118 and may be used to designate a first user input such as select an item. Upon activating a second switch, the electromagnet 1006 may be activated with a second magnetic field of a second polarity. Once detected, this second polarity may be used to designate a second user input such as deselecting an item.

The electromagnet 1006 may be disposed elsewhere within the stylus 110. For example, the electromagnet 1006 may be disposed proximate to the stylus tip 112. Or, the electromagnet 1006 may be disposed around the primary alignment magnet 702.

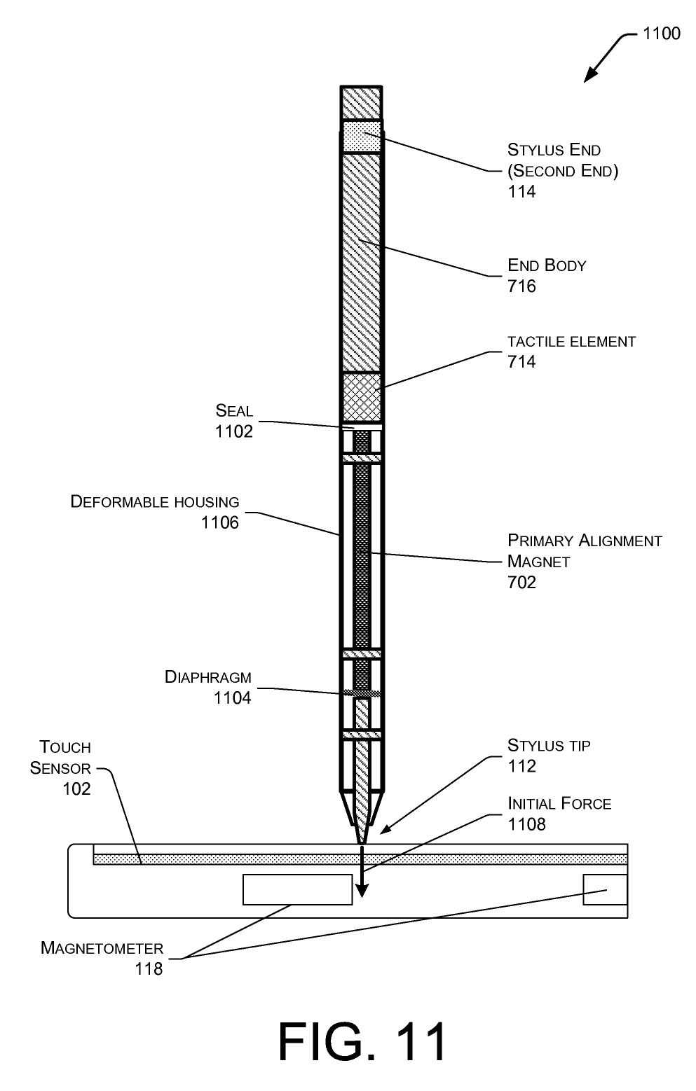

FIG. 11 is a cross section 1100 of an illustrative stylus configured to accept a squeeze input. A squeeze comprises an application of at least a pair of opposing forces generally perpendicular to the long axis of the stylus. This squeeze input may be accepted and determined as a user input by the input module 106. When the touch sensor 102 is configured to detect a magnitude of applied force, the stylus 110 may be configured as shown to convert a squeeze into an increased pressure on the touch sensor 102.

As shown in this illustration, a seal 1102 and a diaphragm 1104 as bounded by a deformable housing 1106 provide a sealed cavity in the stylus 110. The diaphragm 1104 is configured to flex in response to a change in air pressure on at least one side. The diaphragm 1104 is mechanically coupled to the stylus tip 112 such that a displacement of the diaphragm 1104 results in a displacement of the stylus tip 112 along the long axis of the stylus 110. The deformable housing 1106 is configured to deform and rebound at least partially in response to an applied force. As shown here, in the absence of a squeeze being applied to the deformable housing 1106, the stylus tip 112 is applying an initial force 1108.

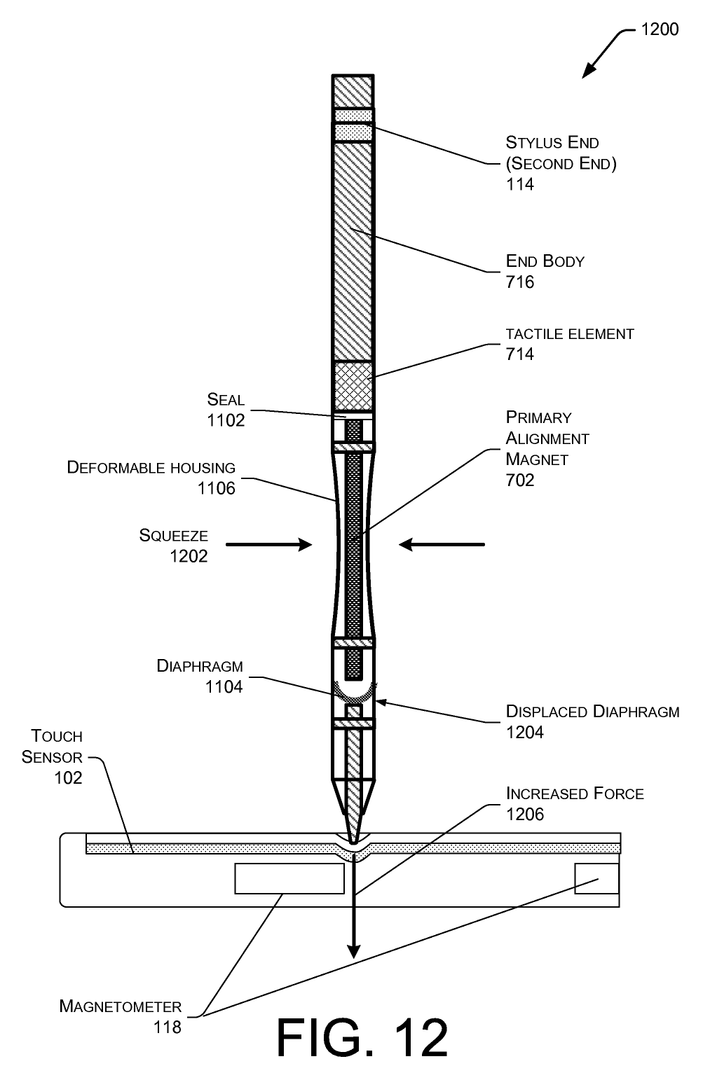

FIG. 12 is a cross section 1200 of the stylus of FIG. 11 when a squeeze 1202 is applied to the deformable housing 1106, such as by a user. Upon squeezing the deformable housing 1106, air pressure within the cavity results in a displacement 1204 of the diaphragm 1104 which in turn results in a displacement of the stylus tip 112 and an increased force 1206 on the touch sensor 102. In some implementations the increased force 1206 may be transitory and the mechanism of the stylus 110 configured to apply the increased force 1206 for a moment of time. For example, a “click” of pressure lasting 100 ms or less.

Where the touch sensor 102 is configured to determine the magnitude of the applied force, this increased force 1206 may be recognized by the input module 106 as a user input. While FIGS. 12 and 13 illustrate translating the force of a squeeze via the diaphragm 1104, it is to be appreciated that other embodiments may transmit this force in other ways.

FIG. 13 is a plan view 1300 of the electronic device 100 and a magnetometer 118 sensing the magnetic stylus. The magnetometer 118 or other magnetic field sensor allows for the detection and characterization of an impinging magnetic field. For example, the magnetometer 118 may determine a field strength, angular bearing, polarity of the magnetic field, and so forth. Because magnetic fields, particularly in the environment within which electronic devices operate, are generally predictable and well understood, it becomes possible to determine proximity and in some implementations, the position, orientation, and so forth of the magnetic stylus.

As shown in this illustration, the stylus 110 is positioned above the surface of the device 100. Shown at approximately the center of the device 100 is the magnetometer 118, which may be disposed beneath the display 104. In other implementations, the magnetometer 118 (and/or additional magnetometers) may reside in other locations within or adjacent to the device.

The magnetometer 118 senses the magnetic field 704 generated by the primary alignment magnet 702 within the stylus 110, and is configured to characterize the magnetic field. An angle θ₁ is depicted describing an angle between a field line of the magnetic field 704 and the Y axis of the device. A single angle θ₁ is shown here for clarity, but it is understood that several angular comparisons may be made within the magnetometer 118. By analyzing the angular variation and utilizing known characteristics about the primary alignment magnet 702, the device 100 is able to determine an angular bearing to the source. For example, assume that the magnetometer 118 is configured to read out in degrees, with the 12 o'clock position being 0 degrees, and increasing in a clockwise fashion, device 100 may determine the stylus is located at an angular bearing of about 135 degrees relative to the magnetometer 118. In some examples, individual magnetic field sensors sense magnetic field along only one direction, and so multiple magnetic field sensors, generally oriented orthogonally with respect to each other (or oriented such that they respectively measure generally orthogonal magnetic field components) are used.

Furthermore, the magnetometer 118 may also determine a field strength measurement H₁ as shown. When compared to a known source such as the primary alignment magnet 702 within the stylus 110, it becomes possible to estimate distance to a magnetic field source based at least in part upon the field strength.

The input module 106 may also use data from the magnetometer 118 to determine a field orientation. The orientation of a magnetic field may be considered the determination of which end of the magnet is the North pole and which is the South pole. This field orientation may be used to disambiguate the angular bearing (for example, determine the bearing is 135 and not 315 degrees), determine which end of the stylus 110 is proximate to the device, and so forth.

In some implementations, the input module 106 may provide a calibration routine whereby the user places the stylus in one or more known positions and/or orientations, and magnetometer 118 output is assessed. For example, the device 100 may be configured to calibrate field strength, position, and orientation information when the stylus 110 is docked with the device 100. This calibration may be useful to mitigate interference from other magnetic fields such as those generated by audio speakers, terrestrial magnetic field, adjacent electromagnetic sources, and so forth.

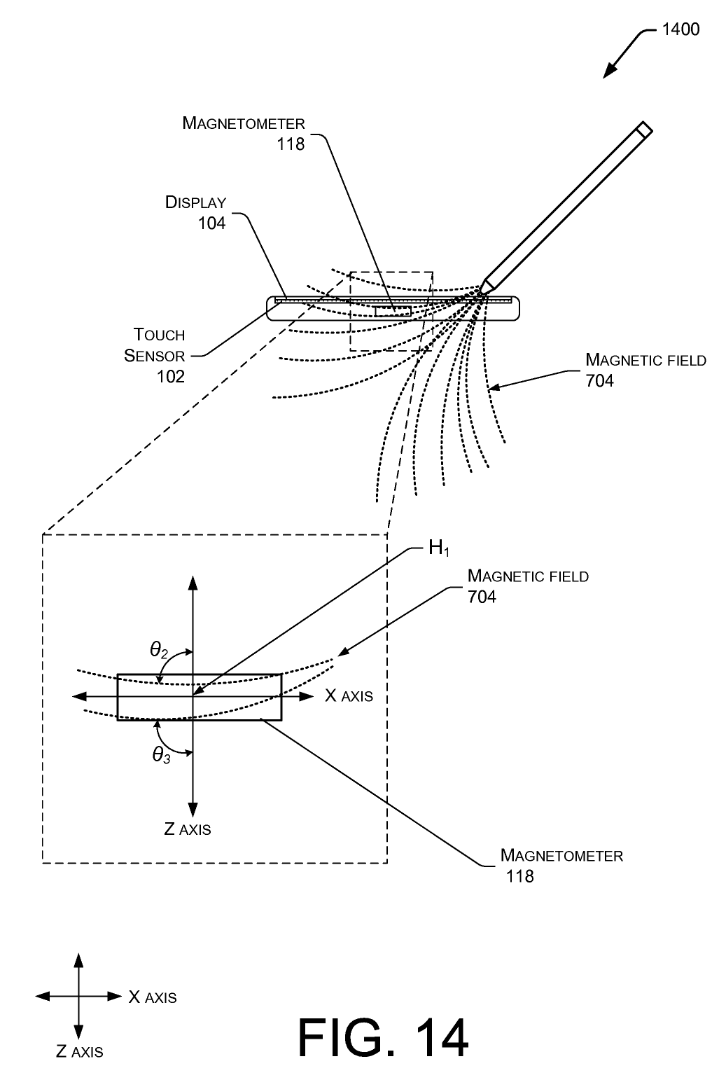

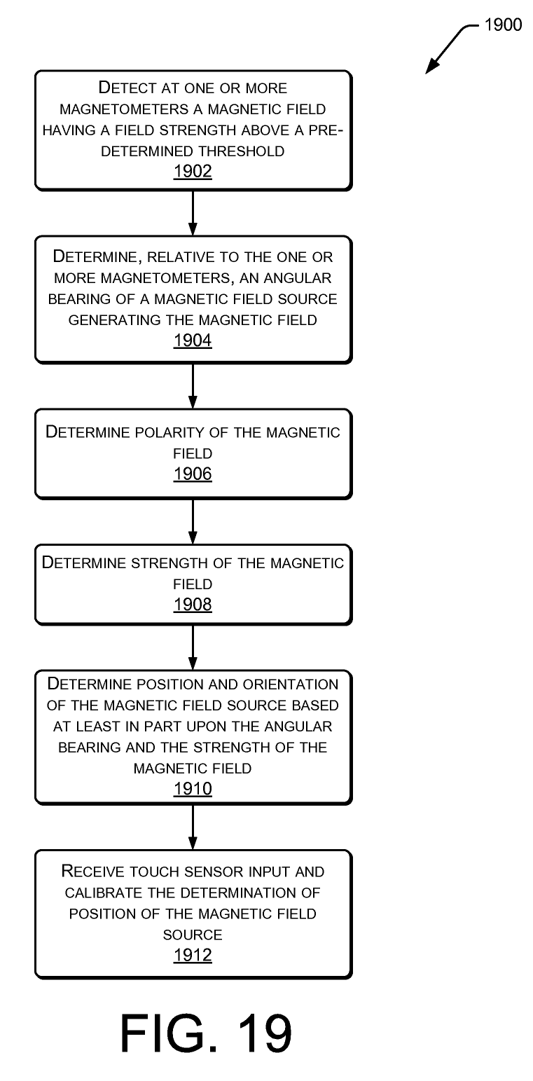

FIG. 14 is a cross section 1400 of the electronic device 100 of FIG. 19. In this view along cross section line C1 of FIG. 13, the disposition of the magnetometer 118 beneath the display 104 as well as the impinging magnetic field lines 704 are depicted. While the stylus 110 is shown touching the surface of the device 100, it is understood that the stylus is not required to be in contact with the touch sensor 102 or the device 100 for the magnetometer 118 to sense the impinging magnetic field. Because the magnetic field propagates through space, near-touch or non-contact input is possible.

As described above it is possible to determine an angular bearing of the magnetic field source, such as the primary alignment magnet 702 within the stylus 110, relative to one or more of the magnetometers 118. In a similar fashion it is possible, as shown here, to measure angles of an impinging magnetic field 704 to determine a tilt angle of the magnetic field source. Due to the closed loop nature of magnetic fields which extend unbroken from a first pole to a second pole, better results may be obtained from using longer magnets. For example, where the primary alignment magnet 702 extends substantially along the stylus body 710, better angular resolution is possible compared to a short magnet placed within the stylus tip 112. Extended magnetic field lines produced by a longer magnet may reduce field flipping or ambiguity compared to a shorter magnet. For example, the relative angle of the larger magnetic field impinging on the magnetic field sensor may be more easily and accurately determined than a magnetic field which is generated by a smaller magnet. Furthermore, distance to the object along the angular bearing may be determined by analyzing the strength of the magnetic field source at the magnetometer 118.

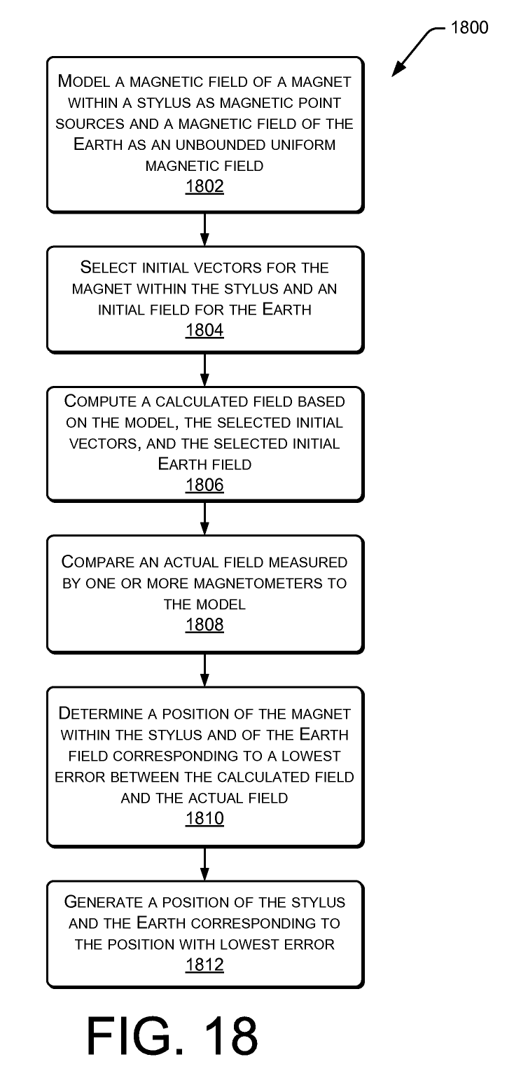

In some implementations, the determination of the angular bearing, orientation, and tilt may be determined as part of a gradient descent process based on input data from a plurality of magnetometers 118. As described below with regards to FIG. 18, the gradient descent incrementally adjusts a selected initial vector to determine a position with a lowest error relative to the actual field components measured by the plurality of magnetometers.

As shown here, the magnetic field 704 impinges on the magnetometer 118 and angles θ₂, and θ₃ are described between the magnetic field lines 704 and a defined reference plane such as the X-Z plane shown here. By comparing the field strength to estimate distance and by measuring the angles, it is thus possible to calculate a tilt angle of the stylus relative to the reference plane defined within the magnetometer 118, and thus the device 100. Additionally, as mentioned above, by determining the polarity of the magnetic field, it is possible to determine which end of the stylus is proximate to the device.

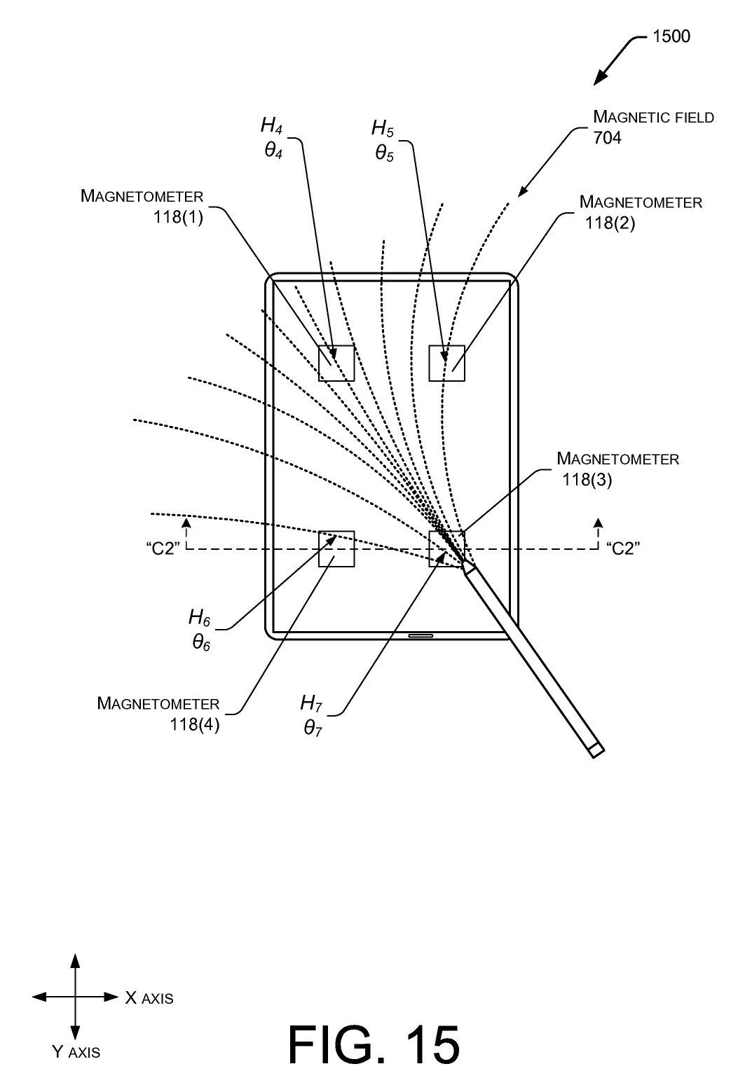

Additional magnetometers may be used to provide more accurate position information. FIG. 15 is a plan view 1500 of the electronic device 100 and plurality of magnetometers. In this illustration, four magnetometers 118(1)-(4) are depicted arranged beneath the touch sensor 104. As described above, each of the magnetometers 118 may be configured to detect a relative angular bearing of the magnet within the stylus and a relative magnetic field strength. For example, as shown here, the magnetic field 104 as measured in the X-Y plane at the magnetometers results in angles of θ₄ at magnetometer 118(1), θ₅ at magnetometer 118(2), θ₆ at magnetometer 118(4) and θ₇ at magnetometer 118(3). By providing two or more magnetometers within the device, position resolution may be improved, as well as resistance to external magnetic noise sources.

In addition to determining location based upon the angle of impinging magnetic fields, field strength H may be used to determine approximate location. For example, given the position of the stylus 110 and corresponding primary alignment magnet 702 adjacent to magnetometer 118(3), close to magnetometer 118(4), and most distant from magnetometer 118(1), based upon the field strength the position of the magnetic field source may be triangulated.

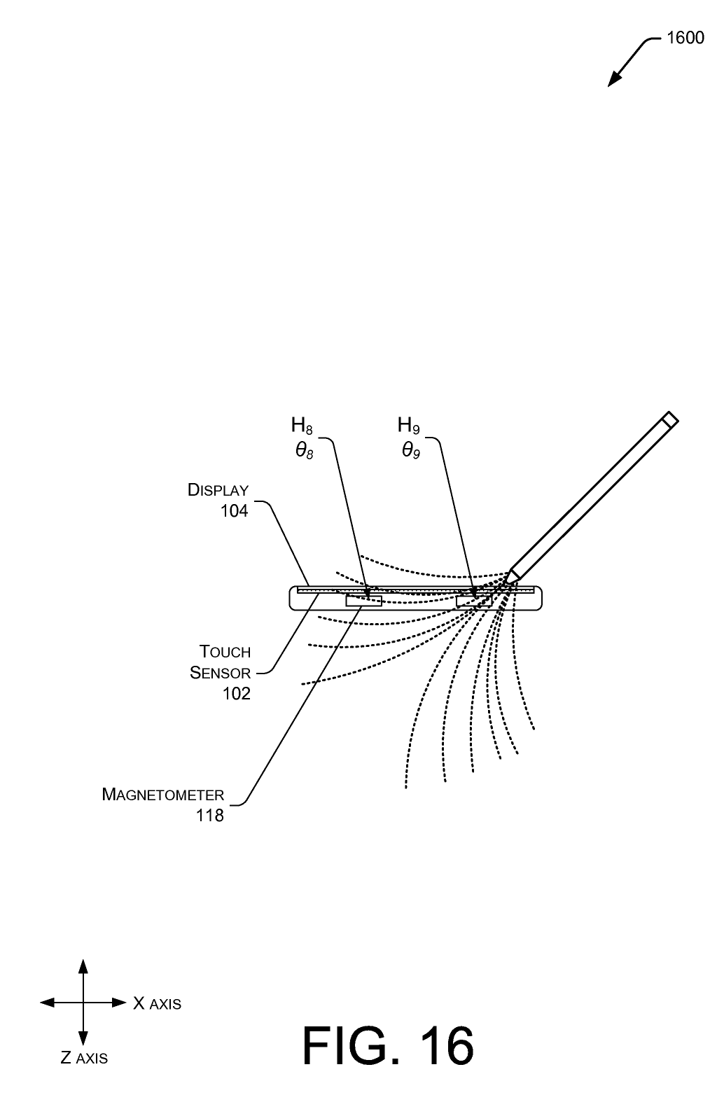

FIG. 16 is a cross section 1600 of the electronic device of FIG. 15 along line C2 of FIG. 15. Similar to that described above with respect to FIG. 14, the magnetic fields 704 impinging on the magnetometers may be measured to determine linear field components or angles in the X-Z plane as shown here with angles θ₈ and θ₉. The magnetometer 118 data may be used to determine the bearing, tilt angle, position, or other information about the stylus. The placement of magnetometers throughout a working input area of the device 100 allows for improved determination of tilt angle.

Furthermore, as mentioned above, by observing the polarity of the magnetic field, it is possible to determine accurately which end of the stylus 110 is proximate to the device. This is particularly useful in situations where the touch sensor is not able to generate force-based touch profile data, such as with a projected capacitance touch sensor. By monitoring the magnetic field orientation, determination of whether a stylus tip 112 or a stylus end 114 is closest to the touch sensor is readily accomplished with a stylus having a primary alignment magnet within.

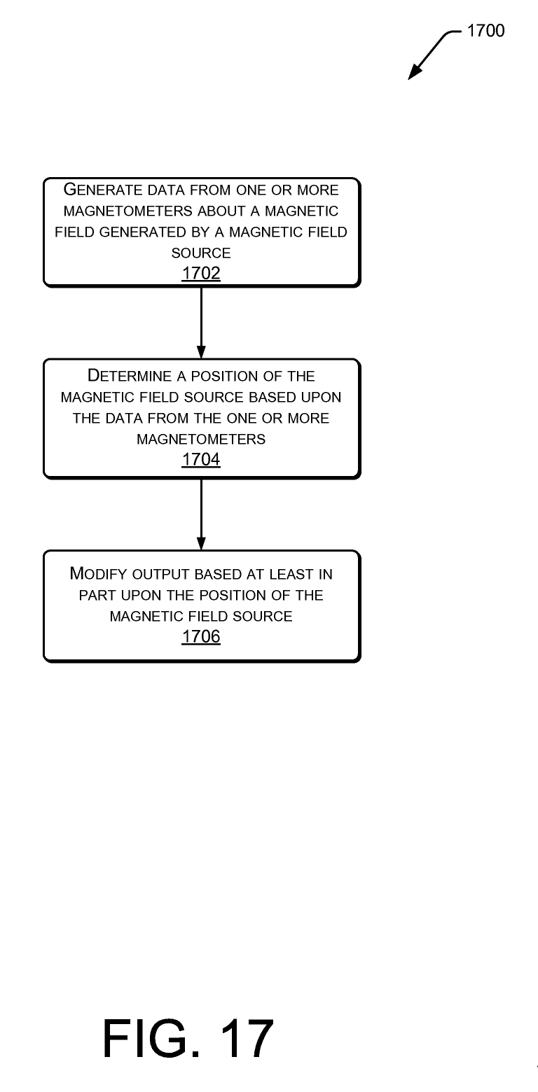

FIG. 17 is an illustrative process 1700 of determining a position of a magnetic field source based upon data from one or more magnetometers. This allows for near-touch sensing and enhances the performance of touch sensors.

At 1702, one or more magnetometers detect a magnetic field generated by a magnetic field source and generate data about the field. This data may comprise linear components in a plurality of mutually orthogonal axis, angular data, and so forth. At 1704, an input module 106 determines a position of the magnetic field source based upon the data from the one or more magnetometers. For example, as described above with regards to FIGS. 13-16, angular bearing, field strength, polarity, and so forth may be used to determine a location of the primary alignment magnet.

At 1706, output is modified at least in part based upon the position of the magnetic field source. As described above, the input generated by the magnetic field source may be near-touch. For example, the user may wave the magnetic stylus above the device 100 to initiate an action, such as changing a displayed page of an eBook. Or in another example, the tilt angle of the stylus may control how fast the display 104 scrolls pages, thickness of a line being drawn on the display 104, and so forth.

A distance between the stylus 110 as determined by the magnetic field generated by the magnet within the stylus may be used to reduce false touches or other erroneous input on the touch sensor 102. For example, when the stylus 110 approaches the touch sensor 102 to within 10 mm or less, input from the touch sensor 102 may be disregarded. This approach distance comprises a pre-determined distance threshold which may be static or dynamically adjusted. In some implementations, a retreat distance which is the distance when the stylus 110 moves away from the touch sensor 102 may be used to determine when the touch sensor 102 is re-enabled to accept input. For example, the retreat distance may be configured to about 20 mm, such that touch input is enabled when the stylus is 20 mm or farther away from the screen. Thus, the approach distance to disable or disregard touch sensor input may be asymmetrical from the retreat distance to enable or accept touch sensor input.

The approach distance, retreat distance, or both may also be used to alter touch sensitivity of a force sensitive touch sensor, such as the IFSR touch sensor. For example, when the stylus 110 is within the approach distance, the IFSR sensor 102 may require 40% more applied pressure for the touch to be considered input. Such a change to the amount of pressure required to register on the touch sensor aids in preventing undesired or inadvertent inputs.

FIG. 18 is an illustrative process 1800 of generating a computed position of the stylus based on a model of the magnetic field. At 1802, a model is generated of the magnet within the stylus 110 as magnetic point sources and a magnetic field of the Earth as an unbounded uniform magnetic field. The Earth's magnetic field may also be considered to be a single vector, given the field size relative to the size of the device. As used herein, the magnetic field of the Earth may include that which is generated by the Earth as well as other ambient magnetic fields present in the environment. Each source may be modeled as two point sources of magnetism. For example, a single “North” magnetic monopole and a single “South” magnetic monopole.

At 1804, initial vectors for the magnet and an initial field for the terrestrial magnetic field are selected. In some implementations, these initial vectors for the magnet may be for the stylus 110 at a neutral position such as orthogonal to the X-Y plane of the device with the stylus tip 112 pointed towards the touch sensor 102 in the center of the device in the X-Y plane. In some implementations, the Earth's magnetic field or other ambient magnetic fields may be set to an initial null or no field. This selection may be based at least in part upon other sensor inputs such as the orientation sensors 120, or be pre-determined such as an assumed initial start position. In some implementations this assumed initial start position may comprise a stylus receptacle, such as described below with regards to FIG. 30.

At 1806, a calculated field is computed based on the model, the selected initial vectors, and the selected initial Earth field. At 1808, an actual field such as measured by the magnetometers 118 is compared to the model. These actual field data may include field flux density, distribution, angle, and so forth. In some implementations a terrestrial magnetic field such as the Earth's magnetic field or other ambient magnetic field may be addressed by treating it as a field applying equally to all magnetometers.

At 1810, a position of the magnet within the stylus and of the Earth corresponding to a lowest error between the calculated field and the actual field is determined. In one implementation, this may comprise application of a gradient descent which incrementally adjusts the selected initial vectors to determine a position with a lowest error relative to the actual field. In some implementations, the gradient descent may be applied to a particular axis or to several axes at the same time. The position of lowest error may be that which exhibits an error below a pre-determined threshold, a local minima, or a global minima The gradient descent is configured to determine a local error minima which denotes a calculated field and corresponding position and orientation of the primary alignment magnet 702 within the stylus 110 which corresponds most closely to the magnetic fields measured by the magnetometers 118.

To improve accuracy, in some implementations the system may be configured to avoid local minimums which may lead to sub-optimal position determinations. To avoid local minimums, the system may vary step size, trying a plurality of locations at difference distances. Over time, the step size may be reduced. Local minimums may also be avoided by injecting random positions for the stylus 110, or using pre-determined positions. Each of these tested positions are accepted when their error is lower than the current position, and otherwise discarded.

The magnetic field of the terrestrial magnetic field or other sources may be of the same order of magnitude as the field produced by the one or more magnets within the stylus 110. Accuracy of the tracked position of the one or more magnets may be improved by compensating for these other magnetic fields. Improved detection of the terrestrial magnetic field also may improve quality of navigational data, such as the geographic direction the device 100 is pointing or moving along.

In one implementation, the user may be prompted to move the stylus 110 and corresponding magnet to at least a pre-determined distance. Once at this pre-determined distance the user terrestrial and other ambient magnetic fields may be measured by the one or more magnetometers 118 to determine a background magnetic environment. This background magnetic environment may then be used to compensate when the stylus magnetic field is brought back into detection range of the device.

In another implementation, the terrestrial or other magnetic field may compensated for by treating this field as another variable which is adjusted for within the gradient field descent operation during computation of stylus 110 position and orientation. The computed terrestrial magnetic field may be represented as a vector with three components (x,y,z) which are added to the magnetic field computed for the stylus at the location of one or more of the magnetometers 118. During successive passes of the gradient descent, the x, y, and z components of the terrestrial magnetic field may be varied to find a combination of the terrestrial magnetic field and stylus position and orientation which results in the closest match to the observed actual magnetic field at the one or more magnetometers 118.

Generally, terrestrial magnetic fields vary slowly over time scales of ten minutes or less. As a result, previously computed gradient descent data related to the terrestrial magnetic field may be stored and reused for a pre-determined period of time. This may reduce computational overhead, corresponding power consumption, and may also improve response time. Furthermore, because the terrestrial magnetic fields vary slowly over these time scales, the terrestrial magnetic field in the model may be varied by small increments, further improving accuracy of the computed position of the stylus 110.

The terrestrial magnetic field and other ambient magnetic fields may be considered and adjusted as described at intervals to account for a moving device. The interval may be adjusted according to input from other sensors. For example, the terrestrial magnetic field and ambient magnetic fields may be computed when an accelerometer or gyroscope detects a movement of the device 100.

The gradient descent may also be used to determine which end of the stylus is proximate to the touch sensor 102. Where the orientation of the magnetic field in relation to the stylus 110 is known a priori, the orientation of the stylus 110 may be determined. For example, where the primary alignment magnet 702 within the stylus is known to be configured such that the North pole of the magnet is proximate to the tip, results from the gradient descent which will also indicate which end of the stylus 110 is proximate.

At 1812, a position of the stylus is generated comprising the position with the lowest error. As a result, the position of the stylus 110 may be tracked in three-dimensions even when free from physical contact with the device 100. Tracking may also occur by assuming or determining the stylus is at one of multiple pre-determined locations on the device and a position and orientation may be computed based on this assumption when compared with the actual data from the one or more magnetometers 118.

While gradient descent is discussed herein, other optimization techniques may also be used. Optimization techniques include, but are not limited to, stochastic gradient descent, conjugate gradient method, quasi-Newton methods, and so forth.

FIG. 19 is an illustrative process 1900 of further determining the position and orientation of a magnetic field source. At 1902, one or more magnetometers detect a magnetic field having a strength above a pre-determined threshold. This pre-determined threshold may be configured or calibrated to ignore the terrestrial magnetic field, or dynamically adjusted such as to adjust for magnetic fields generated by audio speakers within the device 100. This calibration may include the use of offset values and scaling factors to adjust for factors such as manufacturing variances, aging of the device, varying temperature, ambient magnetic fields, and so forth.

At 1904, the input module 106 determines an angular bearing relative to the one or more magnetometers of a magnetic field source generating the magnetic field. For example, as described above the input module 106 may observe the angle with which the magnetic fields impinge upon the magnetometers and determine the angular bearing.

At 1906 a polarity or orientation of the magnetic field is determined. As described above, this orientation may allow for disambiguation of the angular bearing, provide information as to what part of the magnetic stylus is proximate to the device, and so forth.

At 1908, a field strength of the magnetic field is determined at one or more of the magnetometers. At 1910, the input module 106 determines position and orientation of the magnetic field source based at least in part upon the angular bearing, the field strength, or both.

At 1912, the input module 106 receives input from the touch sensor 102 and calibrates the determination of the position of the magnetic field source. For example, when the stylus tip 112 of the magnetic stylus touches the touch sensor 102, the device 100 now has an accurate known location of the touch. This known location may be used to adjust the determination of the position via the magnetometers to improve accuracy.

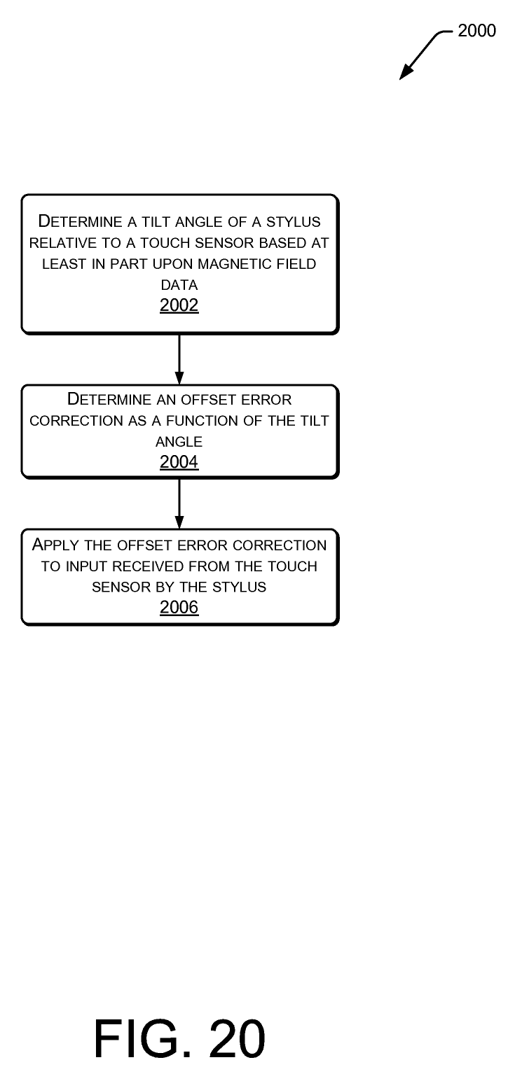

FIG. 20 is an illustrative process 2000 of determining a tilt angle of the stylus and applying an offset error correction to the input. This correction may be applied to a wide variety of touch sensor technologies including IFSR, capacitive, and so forth. Tilt angle is the angle between the long axis of the stylus 110 and the surface which the stylus tip 112 is in contact with. Due to the physical structures of the device 100, when the stylus 110 manifests a tilt angle which is non-orthogonal to the surface, an offset error may occur. For example, when the stylus is held with a 45 degree tilt angle to write on a touch sensor 102 under a display 104, due to the slight thickness of the display 104, the presentation of a line on the display corresponding to the touch of the stylus tip 112 may appear to the user to be slightly displaced. An offset error correction may be generated and applied to shift the position of the input touch to correct for this effect.

This offset error correction may be applied to other touch and stylus tracking methods. For example, capacitive and electro-magnetic resonance (EMR) systems introduce repeatable and systematic errors due to tilt may occur. This is because these methods track a magnetic field rather than the actual tip, resulting in an uncertain position of the tip. Using the techniques described herein, the tilt may be calculated using the magnetometer information, and compensation can be applied. This compensation may comprise a table or function which provides an X,Y position compensation based on the stylus angle.

At 2002, a tilt angle of the stylus 110 relative to the touch sensor 102 is determined based at least in part upon magnetic field data, such as angles θ₂, and θ₃ as described above with regards to FIG. 14. The tilt angle is relative to a plane of the touch sensor, such as the X-Y plane described herein. In some implementations, the tilt angle may comprise angles along perpendicular planes such as within the X-Z and Y-Z planes. In some implementations, the tilt angle may be relative to a normal line extending perpendicularly from the plane of the touch sensor 102. For example, as discussed above with regards to FIG. 13-16 the tilt angle may be determined by measuring the magnetic field of the stylus 110. The tilt angle may also be determined during the determination of the position of the magnetic within the stylus 110 using gradient descent.

At 2004, an offset error correction is determined which is based on (e.g., a function of) the tilt angle. For example, a small tilt angle may result in a small offset, while a large tilt angle may result in a large offset. At 2006, the offset error correction is applied to input received from the touch sensor 102 by the stylus 110.

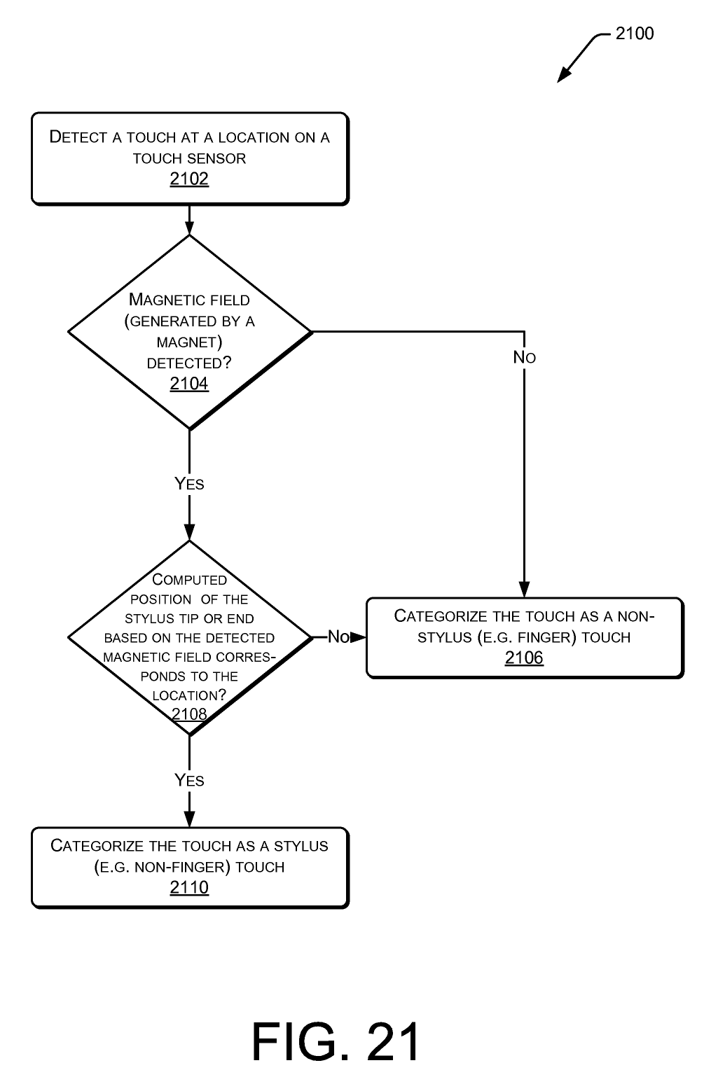

FIG. 21 is an illustrative process 2100 of distinguishing between a non-stylus (e.g. a finger) touch and a stylus (e.g. non-finger) touch based upon the presence or absence of a magnetic field source at the location of the touch on a touch sensor. At 2102, the input module 106 detects a touch at a location on the touch sensor 102. For example, the touch sensor 102 may comprise a capacitive touch sensor and has detected a touch based on a change in capacitance at a particular junction.

At 2104, the input module 106 determines whether a magnetic field such as one generated by a magnet is detected by the one or more magnetometers 118. When at 2104 no magnetic field is detected, at 2106 the input module categorizes the touch as a non-stylus or non-magnetic stylus touch. For example, when the magnetic stylus is a magnetic stylus, a touch without a magnetic field being present must not be the magnetic stylus, and is thus something else.

When at 2104 the input module 106 determines that a magnetic field is detected by the one or more magnetometers 118, the input module 106 module may further compare position information. At 2108, when the computed position of the stylus tip based on the detected magnetic field corresponds to the location of the touch upon the touch sensor 102, the process continues to 2110. At 2110, the input module 106 categorizes the touch as a stylus touch.

Returning to determination 2108, when the position of the detected magnetic field does not correspond to the location of the touch upon the touch sensor 102, the process continues to 2106, where the touch is categorized as a non-stylus (e.g., a finger).

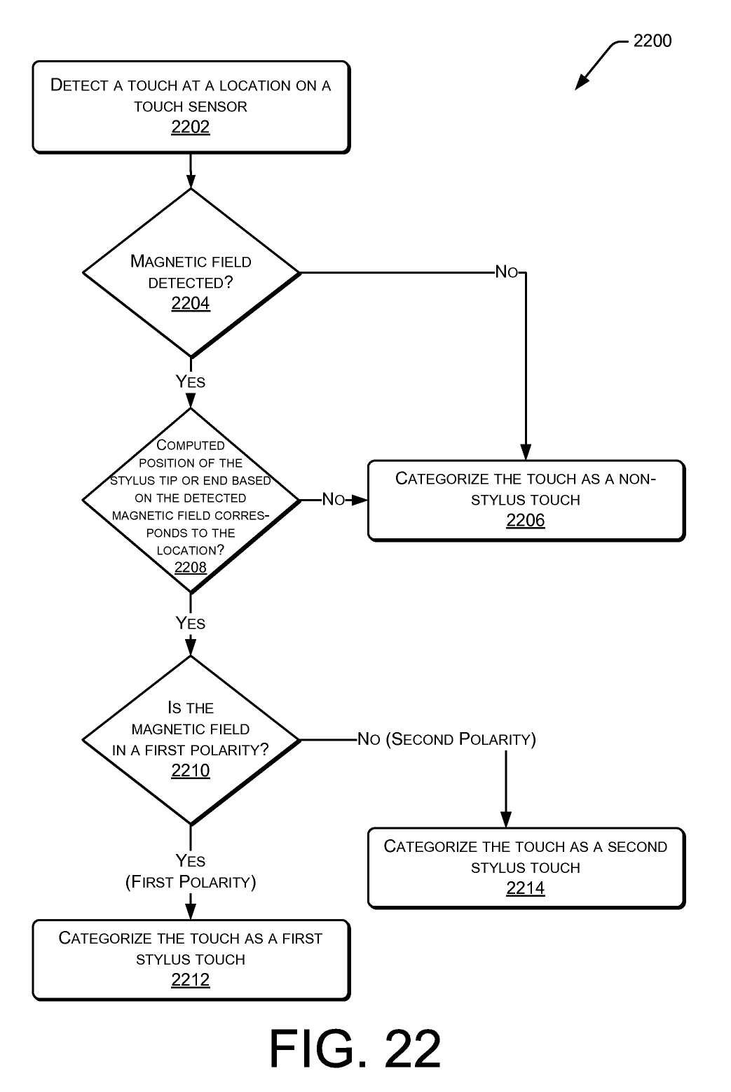

FIG. 22 is an illustrative process 2200 of distinguishing between a non-stylus touch and a or stylus touch based upon the presence or absence of a magnetic field source at the location of a touch on a touch sensor and determining which end of a magnetic stylus is contact based at least in part upon the magnetic field orientation.

At 2202, the input module 106 detects a touch at a location on the touch sensor 102. At 2204, the input module 106 determines whether a magnetic field is detected by the one or more magnetometers 118. When at 2204 no magnetic field is detected, at 2206 the input module categorizes the touch as a non-stylus or non-magnetic stylus touch.

When at 2204 the input module 106 determines that a magnetic field is detected by the one or more magnetometers 118, the input module 106 module may further compare position information. At 2208, when a computed position of the stylus tip or end based at least in part on the detected magnetic field corresponds to the location of the touch upon the touch sensor 102, the process continues to 2210. When at 2208 the position of the detected magnetic field does not correspond to the location of the touch upon the touch sensor 102, the process proceeds to 2206 and categorizes the touch as a non-stylus touch.

At 2210, the input module determines the polarity or orientation of the magnetic field. When at 2210 the magnetic field is in a first polarity, the process proceeds to 2212 and categorizes the touch as a first stylus touch. For example, the north magnetic pole of the stylus may be associated with the stylus tip 112, while the south magnetic pole may be associated with the stylus end 114. By determining the field polarity it is thus possible to distinguish which end of the stylus is proximate to the magnetometers 118, and thus the device 100. When at 2210 the magnetic field is in a second polarity, the process proceeds to 2214 and categorizes the touch as a second stylus touch.

It may be useful to determine which end of the magnetic stylus is proximate to the device, without determining the position of the magnetic stylus via magnetometer. For example, the device 100 may have a touch sensor and single magnetic field sensor unable to determine angular bearing but suitable for determining which end of the stylus 110 is proximate to the device.

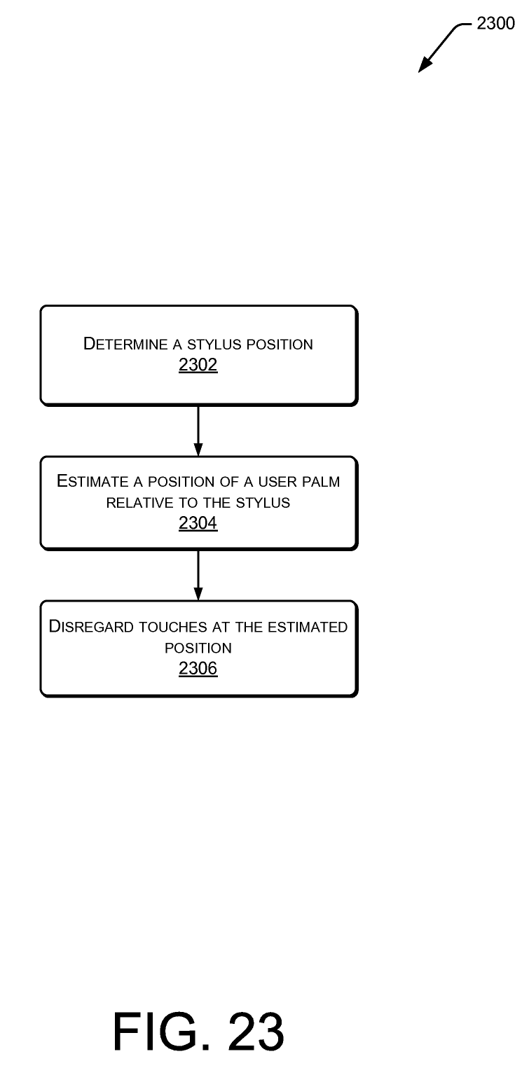

FIG. 23 is an illustrative process 2300 of designating a touch as a non-input touch. For example, an inadvertent palm touch may be disregarded as touch input. At 2302 the input module 106 determines a stylus position. This determination may include use of data from the touch sensor 102 as well as the magnetometers 118.

At 2304, a position of a user palm 302 is determined relative to the stylus 110. This determination may involve the use of a physiological model of a human user hand. At 2306, the user input module 106 disregards touches at the estimated position. As a result, the inadvertent touches such as a palm are disregarded and will not generate erroneous use input.

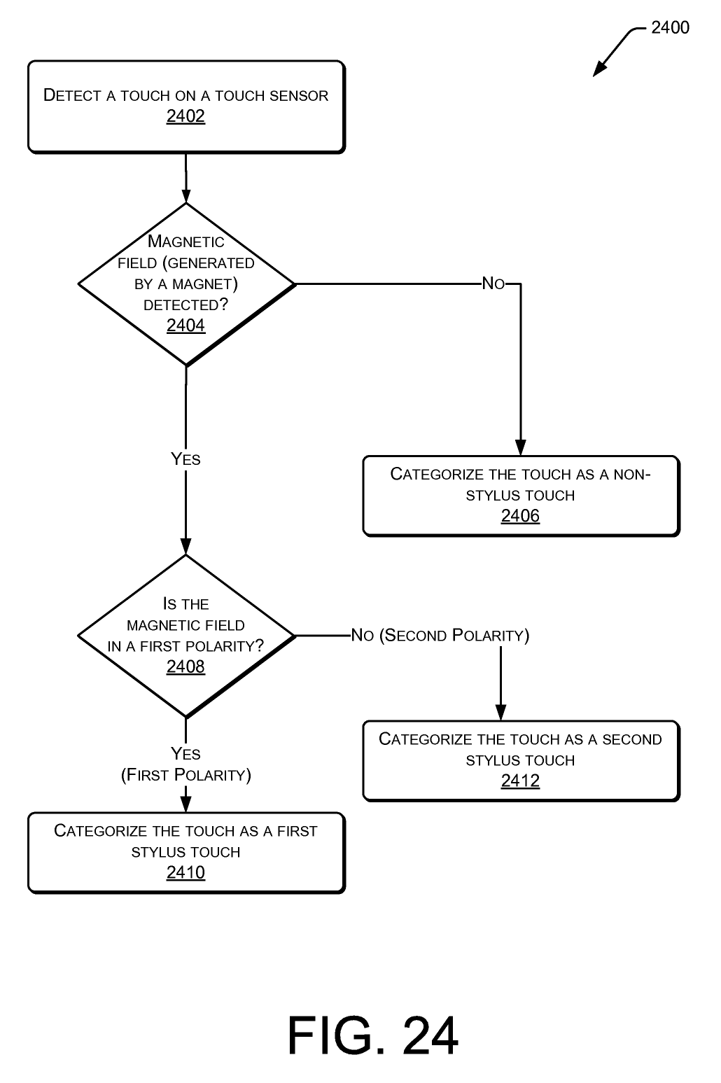

FIG. 24 is an illustrative process 2400 of distinguishing between a non-stylus touch and a stylus touch based upon the presence or absence of a magnetic field source and determining which end of a magnetic stylus is contact based at least in part upon the magnetic field orientation.

At 2402, the input module 106 detects a touch on the touch sensor 102. At 2404, the input module 106 determines whether a magnetic field is detected by the one or more magnetometers 118. When at 2404 no magnetic field is detected, at 2406 the input module 106 categorizes the touch as a non-stylus or non-magnetic stylus touch.

When at 2404 a magnetic field is detected, the process continues to 2408. At 2408, the input module determines the polarity or orientation of the magnetic field. When at 2408 the magnetic field is in a first polarity, the process proceeds to 2410 and categorizes the touch as a first stylus touch. When at 2408 the magnetic field is in a second polarity, the process proceeds to 2412 and categorizes the touch as a second stylus touch.

The input module 106 is now able to more readily determine which end of a magnetic stylus is generating the touch. For example, when the field is oriented a first polarity, the input module 106 can determine that the touch corresponds to the stylus tip 112, while the second polarity indicates the stylus end 114 is closest to the device 100. Likewise, when a touch is sensed with no magnetic field present, the touch is not from the magnetic stylus.

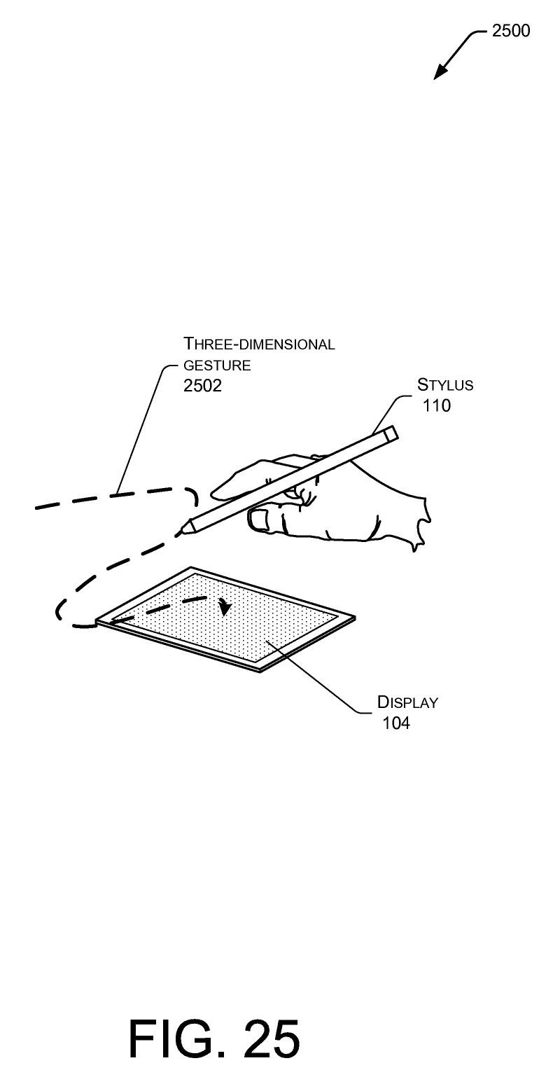

FIG. 25 illustrates a three-dimensional gesture 2500 input using the magnetic stylus 110. Given the magnetometers 118 ability to detect a magnetic field even when the stylus 110 is not in physical contact with the device 110, it is possible to detect gestures made free from contact with the device and use those gestures as input.

The input module 106 may be configured to accept a three-dimensional gesture 2502 made by the stylus 110. These gestures may include holding, waving, spinning, or otherwise manipulating the stylus 110 in space. For example, the user may wave the stylus 110 above the display 104 to change to a next page or perform any other predefined action on the device.

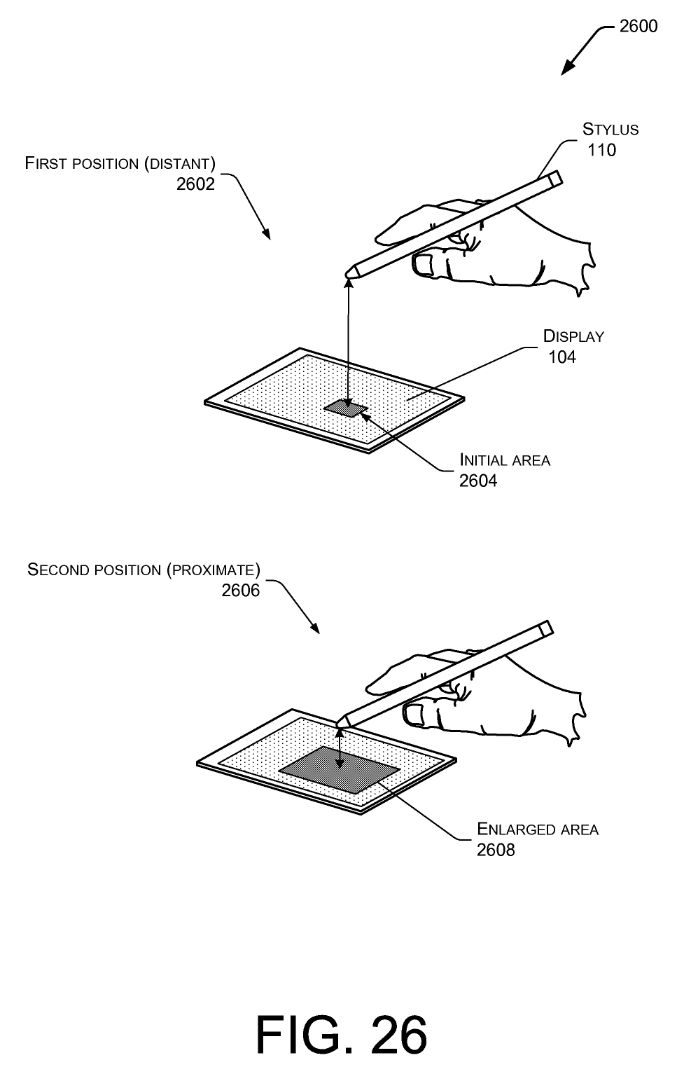

FIG. 26 illustrates varying presentation 2600 of one or more portions of a user interface at least partly in response to a relative distance between the stylus and the touch sensor. As shown in this illustration, at a first (distant) position 2602 the stylus 110 is relatively far from the display 104. As mentioned above, the distance may be determined at least in part by data from the magnetometers 118 detecting one or more magnets within the stylus 110. While in this first position 2602, the display 104 is configured to present a user interface element with an initial area 2604. For example, the user interface element may comprise a note box, configured to accept user input in the form of an annotation.

At 2606, a second (proximate) position 2606 is shown with the stylus 110 closer to the display 104. In response to the decreased distance between the stylus 110 and the display 104, the user interface element now presents an enlarged area 2608. Continuing the example, the note box may be enlarged to increase the space available for the user's handwriting. In some implementations, the relationship may be reversed, such a decreasing the area presented as the stylus approaches.

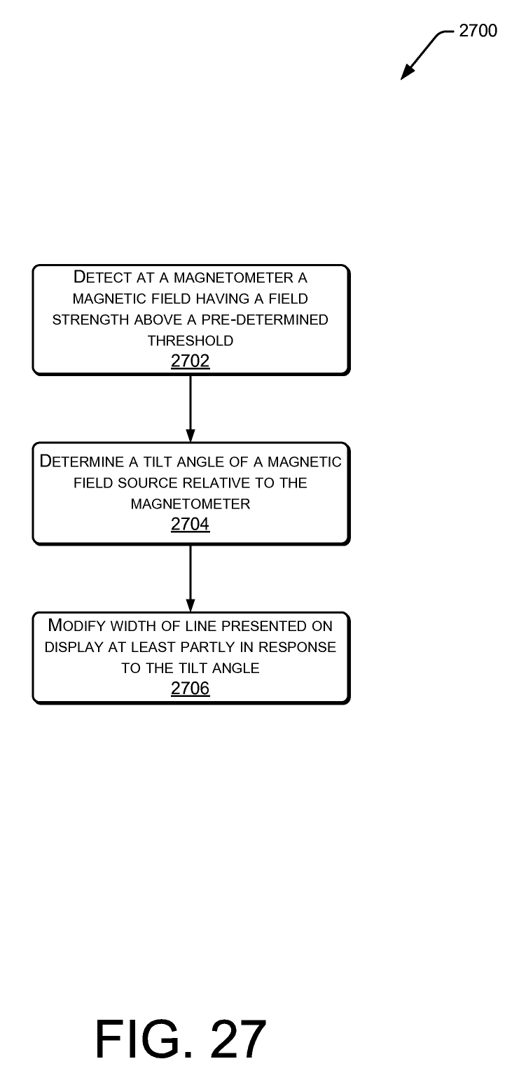

FIG. 27 is an illustrative process 2700 of modifying an input line width based at least partly in response to a tilt angle of the stylus relative to the touch sensor 102. At 2702, a magnetic field having a field strength above a pre-determined threshold is detected at the one or more magnetometers 118. At 2704, as described above, a tilt angle of the magnetic field source relative to the one or more magnetometers 118 is determined. As a result, the tilt angle of the stylus 110 relative to the touch sensor 102 is determined.

At 2706, a width of a line presented on the display 104 is modified at least partly in response to the tilt angle 2706. For example, a small tilt angle may result in a narrow line while a large tilt angle results in a wide line.

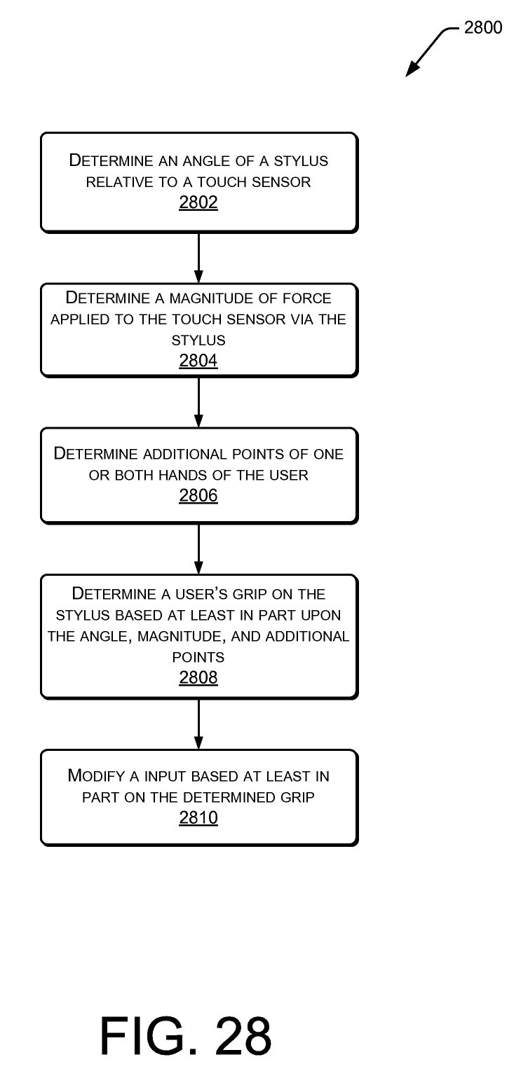

FIG. 28 is an illustrative process 2800 of modifying a user input based at least in part on a determined grip by the user of the stylus. At 2802, an angle of the stylus 110 relative to the touch sensor 102 is determined. At 2804, a magnitude of force applied to the touch sensor 102 via the stylus 2804 is determined. At 2806 additional points of one or both hands of the user on the touch sensor 102 are determined. For example, the presence of fingers of the hand not holding the stylus, or the edge of the hypothenar eminence 320.

At 2808, a user's grip on the stylus 110 is determined based at least in part upon the angle, magnitude, and additional points. For example, at an extreme angle where the stylus tip 112 is touching the touch sensor 102 and the stylus 110 is almost parallel to the touch sensor 102, an overhand grip may be determined due to the inability for the user's hand to occupy the space between the stylus 110 and the touch sensor 102.

At 2810, input is modified based at least in part on the determined grip. Continuing the above example, the overhand grip may initiate a change in drawing tools to that of a simulated watercolor wash.

The input may also be modified by adapting to the usage characteristics of a particular user. For example, the variations in angle, magnitude, and so forth may be used to calibrate the user interface to the user's particular usage.

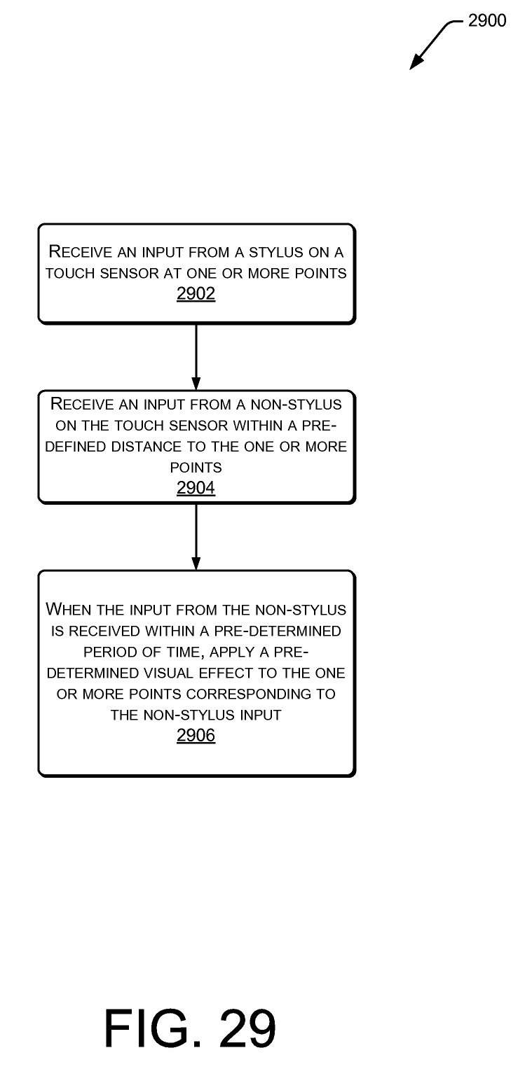

FIG. 29 is an illustrative process 2900 of applying a pre-determined visual effect to one or more points corresponding to non-stylus input. In some usage scenarios, such as drawing, a user may wish to apply a visual effect to at least a portion of the drawing. For example, the user may wish to apply a “smudge” or blur to soften a particular line or set of lines.

At 2902, an input is received from the stylus 110 on a touch sensor at one or more points. For example, the stylus 110 may trace a line comprising a set of points across the touch sensor 102.

At 2904, an input is received from a non-stylus on the touch sensor 102 within a pre-defined distance to the one or more points. For example, a user may use a finger to “rub” across the line.

At 2906, when the input from the non-stylus is received within a pre-determined period of time, a pre-determined visual effect is applied to the one or more points corresponding to the non-stylus input. For example, within thirty seconds of drawing the line, the finger touch may result in a “smudge” visual effect, but a later finger touch outside of the pre-determined period of time would have no effect.

The extent of the visual effect may also vary in proportion to writing instrument used in addition to the amount of time elapsed since the line was drawn. For example, if the user is using the stylus such that the device interprets the input as a charcoal pencil, the device may “smudge” the line much more than if the user were using the stylus as an ink pen. In addition, the device may allow the user to smudge the line drawn by the charcoal pencil for a greater time period than for the ink pend. In either case, as time elapses from the drawing of a line, an otherwise identical rubbing gesture may produce less and less smudging corresponding to a simulated physical process of the line (e.g., charcoal, pen ink, etc.) drying.

FIG. 30 is an illustrative implementation 3000 of the device 100 with a receptacle configured to magnetically stow the stylus. The device may also be configured to detect presence of the stylus in the receptacle.

The device may include a stylus receptacle 3002 or designated location at which the magnets within the stylus 110 are configured to magnetically attach the stylus 110 to the device. This receptacle 3002 may comprise a sleeve, cylinder, partial cylinder, indentation in an exterior case, and so forth. Within the receptacle or inside the device may be ferrous material or complementary magnets 3004 configured to enhance magnetic adhesion between the stylus 110 and the receptacle 3002.

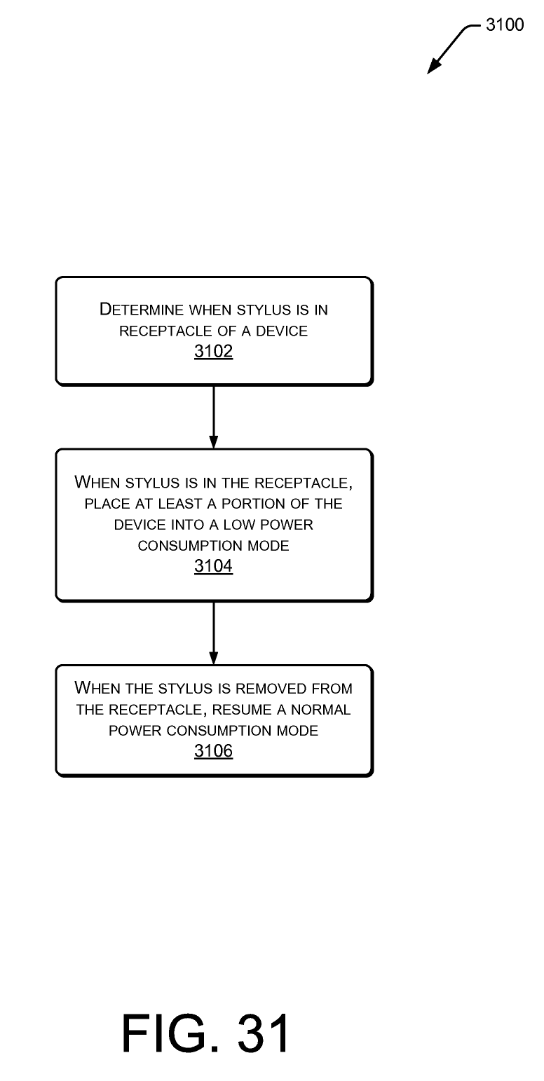

By monitoring the magnetic field 704 of the stylus 110, it is possible to determine when the stylus 110 is present within the receptacle 3002. In one implementation a magnetic switch 3006 may be configured to generate a signal in response to the presence or absence of the stylus 110 in the receptacle 3002. This magnetic switch 3006 may comprise a magnetic reed switch, Hall sensor, and so forth. This signal may be used to alter the operational mode of the device, such as to place the device or portions thereof into a lower power consumption mode. This is discussed in more detail next with regards to FIG. 31.

The input module 106 may be configured to use data from the magnetic switch 3006, the one or more magnetometers 118, or a combination thereof to mitigate loss of a stylus. The input module 106 may be configured to trigger an alert or alarm detectable by the user when the stylus 110 is undetected for a predetermined period of time, or when the stylus 110 has exceeded a pre-determined distance from the device 100. For example, a user who accidentally leaves a stylus and walks away with the device may be prompted with an audible warning.

FIG. 31 is an illustrative process 3100 of determining a change in ambient magnetic fields resulting from placement of the stylus and altering a power consumption mode. At 3102, the input module 106 determines when the stylus 110 is in the receptacle 3002 of the device 100. As described above, this detection may be made by the one or more magnetometers 118, the magnetic switch 3006, and so forth.

At 3104, when the stylus is in the receptacle, at least a portion of the device is placed into a low power consumption mode. For example, the magnetometers 118 may be placed into a lower power scan mode, or disabled to reduce power consumption.

At 3106, when the stylus 110 is removed from the receptacle 3002, normal power consumption mode is resumed. For example, upon removal of the receptacle the magnetometers 118 may be placed into a normal power consumption mode with a higher scan rate and correspondingly increased power consumption.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims For example, the methodological acts need not be performed in the order or combinations described herein, and may be performed in any combination of one or more acts.

What is claimed is:

1. A device comprising:
one or more magnetometers disposed about the device; and
an input module coupled to the one or more magnetometers and configured to:
generate data from the one or more magnetometers regarding a magnetic field generated by a magnetic field source within a stylus; and
determine a position of the stylus relative to the reflective display containing the magnetic field source relative to the device based at least in part upon the data.

2. The device of claim 1, further configured to modify output on the reflective display based at least in part upon the position of the stylus.

3. The device of claim 2, further comprising a reflective display.

4. The device of claim 1, wherein the stylus comprises a tactile element disposed between or incorporated with a stylus tip and a stylus end.

5. The device of claim 1, wherein the position of the stylus is determined in three-dimensions.

6. The device of claim 1, wherein the determining the position comprises:
modeling a magnetic field of the magnetic field source within the stylus as magnetic point sources and a terrestrial magnetic field of the Earth as an unbounded uniform magnetic field;
selecting initial vectors for the magnet within the stylus and an initial field for the Earth;
computing a calculated field based at least in part on the modeling, the selected initial vector, and the initial field for the Earth;
comparing the calculated field with an actual field comprising the data generated by the one or more magnetometers; and
determining a position of the magnet within the stylus and of the Earth corresponding to a lowest error between the calculated field and the actual field.

7. The device of claim 6, wherein the initial vectors are pre-determined.

8. The device of claim 6, wherein the initial vectors are based at least in part on data from one or more orientation sensors.

9. The device of claim 6, wherein the determining the position comprises applying a gradient descent to the calculated field and incrementally adjusting the selected initial vector to generate a position with error below a pre-determined threshold or at a local minima or global minima.

10. The device of claim 1, wherein the position is determined at least in part by analysis of field strength of the magnetic field as measured at the one or more magnetometers.

11. The device of claim 1, wherein the input module is further configured to determine a tilt angle of the stylus relative to the device based at least in part on data from the one or more magnetometers detecting the magnetic field of the magnetic field source within the stylus.

12. The device of claim 11, wherein the input module is further configured to modify input at least partly in response to determining the tilt angle.

13. The device of claim 1, wherein the input module is further configured to determine a polarity of the magnetic field and determine, at least partly with use of the determined polarity, an orientation of the stylus relative to the device at least partly with use of the determined polarity.

14. The device of claim 13, wherein the input module is further configured to modify input at least partly in response to the determining of the polarity and the orientation.

15. A device comprising:
a processor;
a stylus receptacle configured to retain a stylus comprising a magnet effective to create a magnetic field; and
a magnetic sensor coupled to the processor and configured to detect when the stylus is in the stylus receptacle based at least in part on the magnetic field of the magnet of the stylus.

16. The device of claim 15, wherein the stylus is retained in the stylus receptacle by magnetic attraction.

17. The device of claim 15, further comprising an input module configured to change an operational state of the processor at least partly in response to the detection of the stylus by the magnetic sensor.

18. A stylus comprising:
a body having a first end and a second end distal to the first end;
a magnet disposed within or attached to the body;
a stylus tip disposed at the first end;
a stylus end disposed at the second end; and
a tactile element disposed between and coupled to the stylus tip, the stylus end, or both.

19. The device of claim 18, wherein the stylus tip or the stylus end are coupled to the tactile element via the magnet.

20. The device of claim 18, wherein the tip comprises a ballpoint.

21. The device of claim 18, further comprising a mechanism configured to translate at least a portion of a squeeze applied to the body into an increase of force applied to the tip.

22. The device of claim 18, wherein the tactile element comprises an elastomeric material.

23. The device of claim 18, wherein the magnet comprises a rod or bar disposed such that a long axis of the magnet is parallel to a long axis of the body.

24. The device of claim 18, wherein the magnet comprises a first magnet, and further comprising a second magnet disposed such that a long axis of the second magnet is non-parallel to a long axis of the body.

25. The device of claim 18, further comprising a user actuable electromagnet disposed within or attached to the body and configured to generate a magnetic field.

26. The device of claim 18, further comprising a magnet displacement actuator configured to displace the magnet disposed within or attached to the body.

27. A device comprising:
a processor;
a memory coupled to the processor;
a display configured to display content to a user;
one or more magnetometers disposed about the device and configured to detect a magnetic field generated by at least a portion of a stylus;
an input module stored in the memory and coupled to the one or more magnetometers and configured to receive data from the one or more magnetometers regarding the magnetic field generated by at least a portion of the stylus; and
an output module coupled to the processor and the display and configured to modify content presented on the display to the user at least partly in response to the data.

28. The device of claim 27, wherein the display comprises an electrophoretic display.

29. The device of claim 27, wherein the input module is further configured to determine a rotational orientation of the stylus relative to the device about a long axis of the stylus.

30. The device of claim 27, further comprising a touch sensor coupled to the processor and the input module, and wherein the input module is further configured to:
determine a tilt angle of the stylus relative to the touch sensor based at least in part upon the data;
determine an offset error correction based at least in part on the tilt angle; and
apply the offset error correction to input received from the touch sensor by the stylus.

31. The device of claim 27, further comprising a touch sensor coupled to the processor and the input module, and wherein:
the input module is further configured to determine a tilt angle of the stylus relative to the touch sensor based at least in part upon the data; and
the output module is further configured to modify a width of a line on the display at least partly in response to the determining the tilt angle.

32. The device of claim 27, further comprising a touch sensor coupled to the processor and the input module, and wherein the input module is further configured to:
detect a palmar touch comprising a human palm in contact with the touch sensor;
determine a touch profile associated with the palmar touch;
determine when the touch profile matches a previously stored profile associated with a user; and
identify the user based at least in part upon determining that the touch profile matches the previously stored profile associated with a user.

33. One or more computer-readable storage media storing instructions that, when executed by one or more processors, cause the one or more processors to perform acts comprising:
detecting, at one or more magnetometers residing on a device, a magnetic field generated by a magnetic field source associated with a stylus;
generating data about the magnetic field source from the one or more magnetometers;
determining one or more characteristics about the stylus from the data; and
modifying output on the device based at least in part on the one or more characteristics.

34. The one or more computer-readable storage media of claim 33, wherein the one or more characteristics comprise a position of the stylus relative to the one or more magnetometers.

35. The one or more computer-readable storage media of claim 33, wherein the one or more characteristics comprise an angle of the stylus relative to the one or more magnetometers.

36. The one or more computer-readable storage media of claim 33, wherein the one or more characteristics comprise a polarity of the magnetic field source associated with the stylus.

37. The one or more computer-readable storage media of claim 33, wherein the one or more characteristics comprise a gestural sequence of movements by the stylus.

38. The one or more computer-readable storage media of claim 33, wherein the one or more characteristics comprise orientation of the stylus relative to the one or more magnetometers.

39. The one or more computer-readable storage media of claim 33, wherein the one or more characteristics comprise a distance between the magnetic field source associated with the stylus and the one or more magnetometers.

40. The one or more computer-readable storage media of claim 39, wherein the modifying output comprises changing a selection at least partly in response to a variation in the magnetic field strength due to displacement of the magnetic field source relative to a body of the stylus.

41. The one or more computer-readable storage media of claim 39, wherein the modifying output comprises changing a zoom level of a user interface element proportionate to the distance.

42. One or more computer-readable storage media storing instructions that, when executed by one or more processors, cause the one or more processors to perform acts comprising:
receiving an input from a magnetic stylus on a touch-sensitive display at one or more points;
receiving an input from a non-stylus on the touch-sensitive display at or proximate to the one or more points; and
when the input from the non-stylus is received within a pre-determined period of time, applying a pre-determined visual effect to the one or more points corresponding to the non-stylus input.

43. The one or more computer-readable storage media of claim 42, wherein the visual effect comprises a smudge to a line drawn with the stylus on the touch-sensitive display.

44. The one or more computer-readable storage media of claim 42, wherein the input is determined to be a stylus or non-stylus touch based at least in part upon data generated by magnetometers responding to the magnetic stylus.

45. One or more computer-readable storage media storing instructions that, when executed by one or more processors, cause the one or more processors to perform acts comprising:
determining an angle of a magnetic stylus relative to a touch sensor, the magnetic stylus being held by a user;
determining a magnitude of force applied by the user to the touch sensor via the magnetic stylus;
determining additional touch points of one or both hands of the user on the touch sensor;
determining a grip of the user on the magnetic stylus based at least in part upon the angle, the magnitude, and the additional points.

46. The one or more computer-readable storage media of claim 45, the acts further comprising modifying a user input based at least in part on the determined grip.

47. One or more computer-readable storage media storing instructions that, when executed by one or more processors, cause the one or more processors to perform acts comprising:
determining an angle of a magnetic stylus relative to a touch sensor during use by a user;
determining a magnitude of force applied by the user to the touch sensor via the magnetic stylus during use by the user; and
calibrating input by the user to a baseline based at least in part on the angle and the magnitude.

48. A device comprising:
a touch sensor;
one or more processors;
memory, accessible by the one or more processors; and
an input module, stored in the memory and configured to:
determine a position of a stylus at the touch sensor;
estimate a position of a user palm based at least in part on the determined position of the at the touch sensor stylus; and
disregard touches on the touch sensor at the estimated position.

49. The device of claim 48, further comprising:
a stylus configured to generate a magnetic field with a magnetic field source;
and one or more magnetometers configured to generate data from the magnetic field;
and wherein the determining the position of the stylus is based at least in part on the data.

50. The device of claim 48, wherein stylus comprises a primary alignment magnet, a tactile element coupled to a stylus tip, the stylus tip and a stylus end.

51. The device of claim 50, wherein the input module is further configured to determine a polarity of the magnetic field and determine when the stylus tip or the stylus end or both are proximate to the device.

52. A device comprising:
a touch sensor;
one or more magnetometers;
one or more processors;
memory, accessible by the one or more processors; and
an input module, stored in the memory and configured to:
detect a touch at a location on the touch sensor;
interrogate the one or more magnetometers to determine: (i) when a magnetic field above a pre-determined threshold is present, and (ii) a polarity of the magnetic field above the pre-determined threshold;
at least partly in response to determining that no magnetic field above the pre-determined threshold is present, categorize the touch as a first touch type;
at least partly in response to determining that a magnetic field above the pre-determined threshold is present and is associated with a first polarity, categorize the touch as second touch type; and
at least partly in response to determining that a magnetic field is above the pre-determined threshold is present and is associated with a second polarity, categorize the touch as a third touch type.

53. The device of claim 52, wherein the touch sensor comprises a capacitive touch sensor.

54. The device of claim 52, wherein the touch sensor comprises an interpolating force-sensing resistance sensor.

55. The device of claim 52, wherein the magnetic field is generated by a primary alignment magnet associated with a stylus.

56. The device of claim 55, wherein the first touch type comprises a non-stylus or finger touch, the second touch type comprises a stylus tip and the third touch type comprises a stylus end.
